(19) United States
(12) Patent Application Publication
(10) Pub. No.: US 2004/0049778 A1
(43) Pub. Date: Mar. 11, 2004

(54) Card checking device, electronic payment method using this device and real-time electronic commerce method using this device

(76) Inventors: Hyun-Jong Lee, Chunju-City Chungcheongbuk-Do (KR); Seung-Woo Lee, Chungju-City Chungcheongbuk-Do (KR)

Correspondence Address: FISH & RICHARDSON PC, 225 FRANKLIN ST, BOSTON, MA, 02110, US

(21) Appl. No.: 10/332,971

(22) PCT Filed: Jul. 19, 2001
(86) PCT No.: PCT/KR01/01236

(30) Foreign Application Priority Data
Sep. 4, 2000 (KR) 2000/52037
Aug. 11, 2000 (KR) 2000/46679
Jul. 19, 2000 (KR) 2000/41389

(51) Int. Cl. H04N 7/16; G06F 17/60; G06F 3/00; H04N 5/445; G06F 13/00

(52) U.S. Cl. 725/6; 725/60; 705/26

(57) ABSTRACT

This invention is about card checking device, e-payment and real-time e-commerce. It lets former checking device to have pc-banking ability without damaging it. And it also enables e-payment through checking device, and enables its owner to order in his shop, to pay with e-finance, and to check product's delivery status in real-time.

### TECHNICAL FIELD

This invention is about card checking device, e-payment and real-time e-commerce. It lets former checking device to have pc-banking ability without damaging it. And it also enables e-payment through checking device, and enables its owner to order in his shop, to pay with e-finance, and to check product's delivery status in real-time.

### BACKGROUND ART

Normally card checking devices are constituted with; memory parts including ROM and RAM, CPU, I/O, display, printer, key input, modem, cable line, RS232C(standard for direct data communication between computer and other devices), and card reader. So it has every elements for general PC.

And its ability is far better than the Apple, and used with well-developed network it will easily exceed Apple in terms of hardware performance.

But however good the hardware is, it is useless without proper software. And it is actually the current situation of card checking device. In order for the device to work as PC, it should be possible to run it by key input. But the device is only ran through card input, thus it is impossible to perform as PC.

FIG. 1 is a schematic view showing a hard ware-adaptive constitution and a software-adaptive constitution of the conventional card checking device

The device performs only when; the card(100) has gone through the card reader(104) and the signal is transfered to CPU(108) through I/O(106).

Then the software(112) and hardware(118) in memory chip(110) is activated, and it is shown in display(124). Then it communicates with the other(132) through key input(126) and prints(138) its results.

The former card checking device has only credit card checking program(114) and direct card checking program(116) in its ROM(120) and RAM(122). And the program works with function key(128) and is controlled by number key(130).

But function key(128) has no PC support ability, and number key(130) is only usable after the card has been inserted. So the check device owner A can't use the device other way than to receiving payment for the product.

FIG. 2 is showing former check device's hardware and software routine. It is the case when credit care check program(114) has been called on by using function key through card check device(102).

Credit card check device(102) is used when device owner A(200) tries to sell product to customer B(202), and receives payment with credit card of the customer is B(202).

Credit card checking takes process of; i) the card of the customer B is contacted to the card reader(104) ii) then device(102)'s program(114) asks for confirmation in VAN(210) through public line(208) iii)VAN(210) takes it to card company(212) and let the answer go back through public line(208) to the device(102) iv) when the confirmation is made, then the seller(200) prints and keeps the receipt, and the device(102) sends it to the card company.

But this process doesn't transfer the money from customer B's account(218) to seller's account(220). So the seller should collect the receipt everytime and bill the card company(212) every time.

But the whole process takes more than a week, and if the receipt is lost then nothing can be payed. So now days many owners pay VAN to do it automatically for them.

FIG. 3 is a schematic view showing a hard ware-adaptive operation routine and a soft ware-adaptive processing sequence of the conventional direct card checking device.

It is the case that the direct card check program is activated through function key(128) in card check device(102).

Direct card check device(102) is used when device owner A(200) tries to sell product to customer B(202), and receives payment with direct card of the customer B(202).

Direct card checking takes process of; i) the card of the customer B is contacted to the card reader(104) ii) then device(102)'s program(114) asks for confirmation in VAN(210) through public line(208) iii)VAN(210) takes it to bank's e-sever(304) and let the answer go back through public line(208) to the device(102) iv) when the confirmation is made, then the seller(200) prints and keeps the receipt, and the device(102) sends it to bank again. v) bank's e-server transfers the money from customer B's account(218) to seller's account(220).

This is far better than credit card checking for seller. But the problem is that the direct card checking is very small in amount and not much in use.

And even for the direct card the bank doesn't let the owner know about the transfer. He should go and check for himself. When he wants his money out, it is the same case. And normally the owner A is running the store so he is on very tight time schedule.

So it is very hard for him to go to bank in open hours.

FIG. 4 is a schematic view showing a hard ware-adaptive operation routine and a soft ware-adaptive processing sequence of the conventional PC banking system.

PC banking member(400) is free to check(406) his account or transfer to other accounts(408) real time, using his PC(402)'s key input.

Check is taking process of; i) connecting to bank(216)'s e-server(304) through public line(208) ii) checking the account(412) using key input. Also it is possible to transfer to other accounts(414).

But one should put in the security code(418) which the bank provides through security card(416). This makes transfer to work in password status.

Therefore card check device is just a steel box without card insertion, and it can do nothing by itself. And after the card insertion its use is only limited to ask for confirmation for credit card or direct card to card company of bank. So its PC characteristics are completely ignored.

And the former card check device has only the checking ability of card user(customer)'s credit, not the others such as receiving the payment or checking the account or paying for product.

So the owner has been always on the flexibility crisis, because of credit card payments. The gap of selling and paying time was too much, and even when the payment is not received the owner should buy products.

It was impossible for owner to use bank's PC banking system with check device, and it was not even imaginable to use the device as e-paying device.

Card check device had been undervalued of its high-quality hardware, because of software.

And this is the waste of resources and exactly opposite of the PC ability that information society requires. If check device gets e-paying ability, all the hazards the owners have to go through will be reduced in great terms.

In reality the owners are using auto-transfer and one way but it is not solution. So they have to visit the bank to buy their product.

PC banking system is reducing time and space gap for its members, but it needs PC. So because of the time, space, and money the PC takes, general check stores's doesn't have PC.

With card check device in this status, it was impossible to do e-commerce using the device, not to mention buying and paying for the product in real time. It was impossible to even imagine the owner to stay where he is and do his business one-stop using card check device.

But this kind of thoughts are results of prejudice, which insists that card check device is merely for card users, not PC.

As a result, card check device was spread world-wide, but there was no attempt to use it in real time e-commerce.

But PC banking is very important in stores, because it provides transfer ability which is most needed in product cycling. So PC banking should be recommended more for store owners than individuals. And the method should be using the former card check device as PC, instead of placing PC in every stores.

### DISCLOSURE OF THE INVENTION

Accordingly, the present invention is to solve the aforementioned problems, and it is an object of this invention to provide a card checking device with functions that are necessary for the PC banking without damaging the aforementioned functions for the conventional card checking device.

It is another object of the invention to provide a method in which a card checking device can be used as means for an electronic payment through a PC banking.

It is still another object of the invention to allow a card checking device to have a function that is necessary for a PC communication, a function that is necessary for a merchandise order, and a function that is necessary for an electronic finance (PC banking).

It is a further object of the invention to provide method and apparatus for establishing a real-time server-client networking electronic commerce system which allow a card checking device to realize the real-time electronic commerce using the aforementioned functions.

It is a still further object of the invention to provide method and apparatus in which client communications media such as a PC, a TV, a video, a hand-held phone, a screen phone, and the like can be converted into a tool for a real-time electronic commerce using input and output method and apparatus of the server-client networking electronic commerce system.

To accomplish the above objects, there is provided a card checking device for a PC banking. The card checking device comprises: a processor; a card reader part for generating a card reader signal as a card is read and transmitting the card reader signal to the processor; a key input part for generating a key input signal depending on a key input and transmitting the key input signal to the processor; a picture display part for displaying an input picture or an output picture depending on a command signal of the processor, the input picture displaying an item which an input is requested through the key input part, and the output picture displaying a processing result of the processor; a communication part for connecting the card checking device to an external communications network according to a control of the processor; and a memory connected to the processor, for storing a card inquiry processing program, a PC communications program, and a PC banking program, wherein the processor reads out the card inquiry processing program and carries out a card inquiry processing if the card reader signal is input through the card reader part, and the processor reads out the PC banking program and carries out a PC banking processing if the key input signal is input through the key input part.

According to another aspect of the invention, there is provided a method of mediating an electronic payment using the above card checking device. The method comprises the steps of: receiving a withdrawal account number for designating a withdrawal account, a deposit account number for designating a personal code number and a deposit account, and a transfer content including a transfer amount which is transferred from the withdrawal account number to the deposit account number from the card checking device; outputting the transfer content to a bank server; receiving a transfer result from the bank server; and outputting the received transfer result to the card checking device.

According to a further aspect of the invention, there is provided a method of carrying out an electronic payment using the above card checking device. The method comprises the steps of: inputting a withdrawal account number for designating a withdrawal account, a deposit account number for designating a personal code number and a deposit account, and a transfer content including a transfer amount which is transferred from the withdrawal account number to the deposit account number through the key input part of the card checking device; outputting the transfer content to a bank server; receiving a transfer result from the bank server; and outputting the received transfer result.

According to a still further aspect of the invention, there is a method for electronically searching and ordering a purchase merchandise using the above card checking device. The method comprises the steps of: receiving an order content including number, merchandise name, price, manufacturer's name, and code from the card checking device; outputting the order content to a server of an electronic commerce company; receiving an order result from the server of the electronic commerce company; and outputting the order result to the card checking device. (Real-time ordering unit)

According to a yet another aspect of the invention, there is provide an electronic payment method using the above card checking device. The method comprises the steps of: receiving a withdrawal account number for designating a withdrawal account, a deposit account number for designating a personal code number and a deposit account, and a transfer content including a transfer amount which is transferred from the withdrawal account number to the deposit account number from the card checking device; outputting the transfer content to a bank server; receiving a transfer result from the bank server; and outputting the received transfer result to the card checking device. (Real-time payment settlement unit)

According to the invention, a server unit is constituted such that a purchaser can carry out a real-time electronic commerce using an electronic financial system of a bank which provides an electronic transfer service and an electronic inquiry service, a transfer management code creating unit which moves in combination with a merchandise order content of a purchaser is established in the server unit, a commerce business contract concluding routine under a condition in which the purchaser necessarily uses a code created by the transfer management code creating unit is installed (Real-time electronic commerce business contract concluding unit), the electronic financial system provides only a purchaser who has undergone the routine with an operation routine of the electronic financial system of a corresponding bank, and the electronic financial transfer that is necessary for carrying out the purchaser's contact is allowed to the purchaser who directly accesses to the electronic financial system of the corresponding bank, and thereby a possibility in which information data on the purchaser's paying means is exposed to the server unit of an electronic commerce company, is originally blocked, the server system of the electronic commerce company creates a deposit management DB that is necessary in confirming whether or not the purchaser honors the contract, performs a real-time electronic financial inquiry into a bank selected by the purchaser, stores the inquiry result at the server to create a separate inquiry management DB, comparing the content of the deposit management DB with the content of the inquiry management DB based on the transfer management code to determine whether or not the purchaser has met the payment in real time while the purchaser carries out the electronic financial transfer, and the purchaser's paying conduct is confirmation-ended in real time without any exposure on the paying means of the purchaser. (Real time confirmation unit of payment conduct)

Also, in performing the aforementioned commerce business contract, the invention designs the server unit such that an obligation fulfillment process of the electronic commerce business company versus purchasers is automatically executed starting from transmitting the purchaser's obligation fulfillment conduct confirmed by the process to the banking on-line corner, a step-by-step execution circumstance related with delivery is allowed to be registered in real time at the merchandise distributing base PC and/or the merchandise supplier PC, a PC of the delivery company, and the delivery on-line corner on the server in combination with these PCs in accordance with the design, so that all participants of commerce dealings including the purchaser perceive the delivery progress circumstances in real time.

Moreover, the real-time electronic business of the invention is sorted into a contract conclusion step with the purchaser around the electronic commerce business company, a contract execution step of the purchaser and the electronic commerce company, an obligation execution step of the electronic commerce business company versus the client, and an obligation execution step of the electronic commerce business company versus the supplier and the delivery company, and allows a next step to be carried out when the contract execution fact is confirmed each step, thereby the contract balance is confirmation-ended in real time. (Real-time confirmation unit of contract balance)

Hereinafter, there are described in detail preferred embodiments of the present invention with reference to the accompanying drawings. Although figures are different from each other, like elements are designated by identical reference numerals. It should be understood, however, that the embodiments are designed for the purpose of illustration only and not as a definition of the limits of the invention, and the scope of the invention is defined by the appended claims.

### BRIEF DESCRIPTION OF THE DRAWINGS

FIG. 1 is a schematic view showing a hard ware-adaptive constitution and a software-adaptive constitution of the conventional card checking device;

FIG. 2 is a schematic view showing a hard ware-adaptive operation routine and a soft ware-adaptive processing sequence;

FIG. 3 is a schematic view showing a hard ware-adaptive operation routine and a soft ware-adaptive processing sequence of the conventional direct card checking device;

FIG. 4 is a schematic view showing a hard ware-adaptive operation routine and a soft ware-adaptive processing sequence of the conventional PC banking system;

FIG. 5 is a schematic view for describing an electronic operation of a PC banking system in accordance with one preferred embodiment of the present invention;

FIG. 6 is a schematic view for describing an electronic operation of a PC banking system in accordance with other embodiment of the present invention;

FIG. 7 is a schematic view for describing an electronic operation of a PC banking system in accordance with another embodiment of the present invention;

FIG. 8 is a schematic view for describing card check device which allows PC banking system of FIG. 5, FIG. 6 and FIG. 7.

FIG. 9 is a flow chart for explaining the operation of PC banking system according to this invention.

FIG. 10 is an account check routine of PC banking system shown at FIG. 9;

FIG. 11 is an account performance check routine of PC banking system shown at FIG. 9;

FIG. 12 is an inner-transfer check routine of PC banking system shown at FIG. 9;

FIG. 13 is an outer-transfer check routine of PC banking system shown at FIG. 9;

FIG. 14 is a communication security number change check routine of PC banking system shown at FIG. 9;

FIG. 15 is a transfer security number change check routine of PC banking system shown at FIG. 9;

FIG. 16 is a schematic view of key panel of card check device;

FIG. 17 is a schematic view of connection display of PC banking system;

FIG. 18 is a schematic view of input-output display of PC banking system;

FIG. 19 is a schematic of system block of e-commerce system following the example of this invention;

FIG. 20 is a schematic view of e-commerce company's server system block following the example of this invention;

FIG. 21 is a schematic view of buyer check device's system block following the example of this invention;

FIG. 22 is a schematic view of circulation base's system block following the example of this invention;

FIG. 23 is a system performance diagram of VAN associated real-time e-commerce's process following the example of this invention;

FIG. 24 is a system performance diagram of co-invested real-time e-commerce's process following the example of this invention;

FIG. 25 is a system performance diagram of digital finance card real-time e-commerce's process following the example of this invention;

FIG. 26 is a system performance diagram of VAN directed real-time e-commerce's process following the example of this invention;

FIG. 27 is a flow chart of real-time e-commerce in check machine following the example of this invention;

FIG. 28 is a flow chart of real-time e-commerce in check machine following the other example of this invention;

FIG. 29 is a flow chart of real-time e-commerce in check machine following the other example of this invention;

FIG. 30 is a flow chart of product ordering routine in check machine shown in FIG. 27, FIG. 28 and FIG. 29;

FIG. 31 is a flow chart of PC banking routine in check machine shown in FIG. 27, FIG. 28 and FIG. 29;

FIG. 32 is a flow chart of PC banking routine's each service in check machine shown in FIG. 31;

FIG. 33 is a flow chart of real-time e-commerce in server following the example of this invention;

FIG. 34 is a flow chart of buying process shown in FIG. 33;

FIG. 35 is a flow chart of contract demand shown in FIG. 33;

FIG. 36 is a flow chart of contract performance check routine shown in FIG. 33;

FIG. 37 is a flow chart of contract confirmation check routine shown in FIG. 33;

FIG. 38 is a flow chart of e-commerce company's customer duty-performance routine shown in FIG. 33;

FIG. 39 is a flow chart of e-commerce company's other duty-performance routine shown in FIG. 33;

FIG. 40 is a schematic view for describing a process of real-time e-commerce method in the server following the example of this invention;

FIG. 41 is a schematic view of input-output key control following the example of this invention;

FIG. 42 is a schematic view of connecting display following the example of this invention;

FIG. 43 is a schematic view of registration change display following the example of this invention;

FIG. 44 is a schematic view of product ordering display following the example of this invention;

FIG. 45 is a schematic view of input-output display of PC banking following the example of this invention;

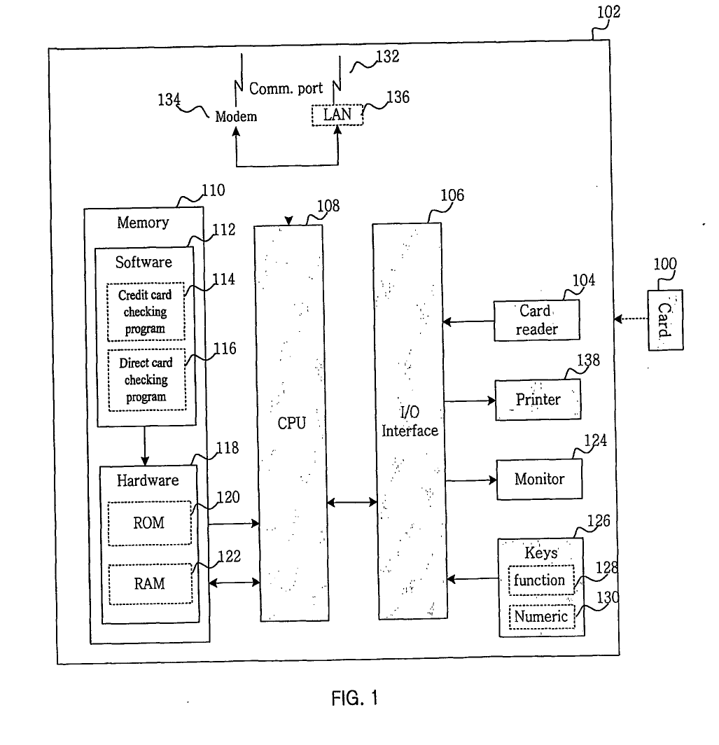

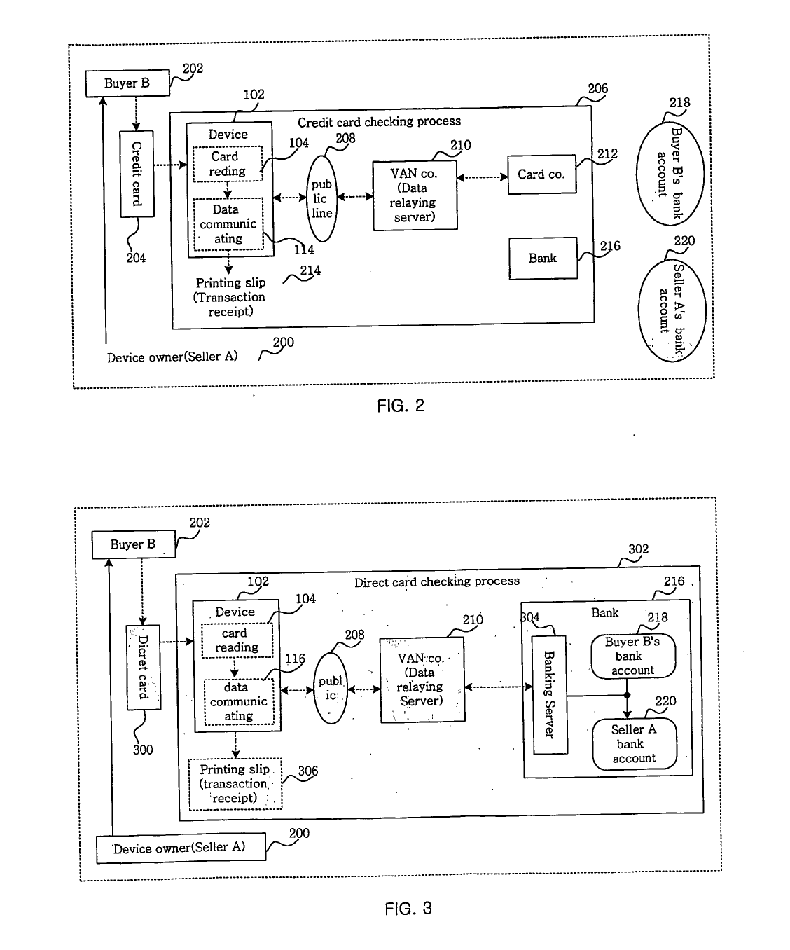

### BEST MODE FOR CARRYING OUT THE INVENTION

Now, preferred embodiments of the present invention will be described in detail with reference to the annexed drawings.

FIG. 5 is a schematic view for describing an electronic operation of a PC banking system in accordance with one preferred embodiment of the present invention

The example shown in FIG. 5 is constituted of; the card reader(502) which contacts the bank(216)'s e-server(304) through VAN(210)'s server(516) to perform as the former card check device(credit card check/or direct card check). And the PC banking part(500) which contacts directly to bank(216)'s e-server(304) without VAN(210)'s server(516) to perform PC banking.

As shown in FIG. 5, in card reader(502), seller A(518) takes the card(100) of buyer B(202) and put it in the card reader(102) in the device(102). The device(102) asks for confirmation in VAN(210) through public line(208), and VAN takes it to card company(212) and bank(216). After that it receives results and sends it back to the check device.

And if the deal is made, it follows the same process of sending the signal to card company or bank.

For better understanding, it's same with the seller getting his money through credit card auto transfer service(DDC: Data & Draft Capture). So every card bill was automatically transferred to his account(220) through bank's e-server(304).

In FIG. 5, PC banking system(500) changes check device(102)'s perform routine, so it can be activated through keyboard(504) input. And it connects to bank's e-server(304) to receive PC banking software, thus transforms the check device to PC banking device. Then it can connect to bank server(304) and does real time account check(506) or banking transfer(508).

And here the transfer from owner(518) to the 3rd person(512) is e-payment, because it is a payment for product buying and selling.

So this case card check device is not only a PC banking device, but also a e-payment device.

By adding the PC banking system to card device, the device owner A(518) is enabled to check(506) his account(220) with keyboard(504) in his card device(102). And also when he buy the product from the producer C(512), he can pay with banking transfer(508) from his account(220) to producer C's account(510) within his store. So he can do buying and paying in real-time. And the banking process must be secured by security code in security card, for the safety of PC banking members.

The most important thing in PC banking in the check device is banking transfer. And the transfer to the 3rd person is a e-replacement for cash, and it is more powerful than IC style e-cash.

And it has very important economic results because it is a bridge between the finance and the circulation.

So with e-paying machine, the owner are free from space and time gap and can concentrate on his business.

And this, the value-creators(check device owner) can specialize, free from paying.

It will make far progress of social production.

There's many other good things with PC banking system added to card check device.

The owner(518) can print(514) the PC banking results, and it is far more convincing than normal PC banking because it has evidence.

And the PC banking is preformed through public line(208) not VAN server(516). So it is cheaper and safer, with security code(418) which only the owner knows.

And if the customer B is PC baking member, he can pay with PC banking. It is also possible for customers to use PC banking through the check device.

FIG. 6 is a schematic view for describing an electronic operation of a PC banking system in accordance with other embodiment of the present invention

This example is divided into; the card checker(502) which the device(102) connects to bank(216)'s e-server(304) through VAN(102) server(516), and the PC banker(600) which the device connects the bank(216)'s e-server(304) through VAN(102) server(516).

That is, the PC banker(600) is also connected to the bank(216)'s e-server(304) through VAN(210) server(516), same as card checker(502).

So the VAN server(516) plays major role in PC banking process in PC banker(600) shown in FIG. 6.

Under this construction the PC banking software is minimized and owner's convenience is maximized through VAN network.

And if VAN offer the other services as shopping, the check device is upgraded even more.

FIG. 6 only shows the owner(518) activating the check device(102) through keyboard(504). But if VAN is between the bank and the device, it is possible to use function key instead of number key.

And with VAN(210) the process of connection to server(516) through public line(208) is monopolized, and data transfer between VAN server(516) and bank server(304) is very fast.

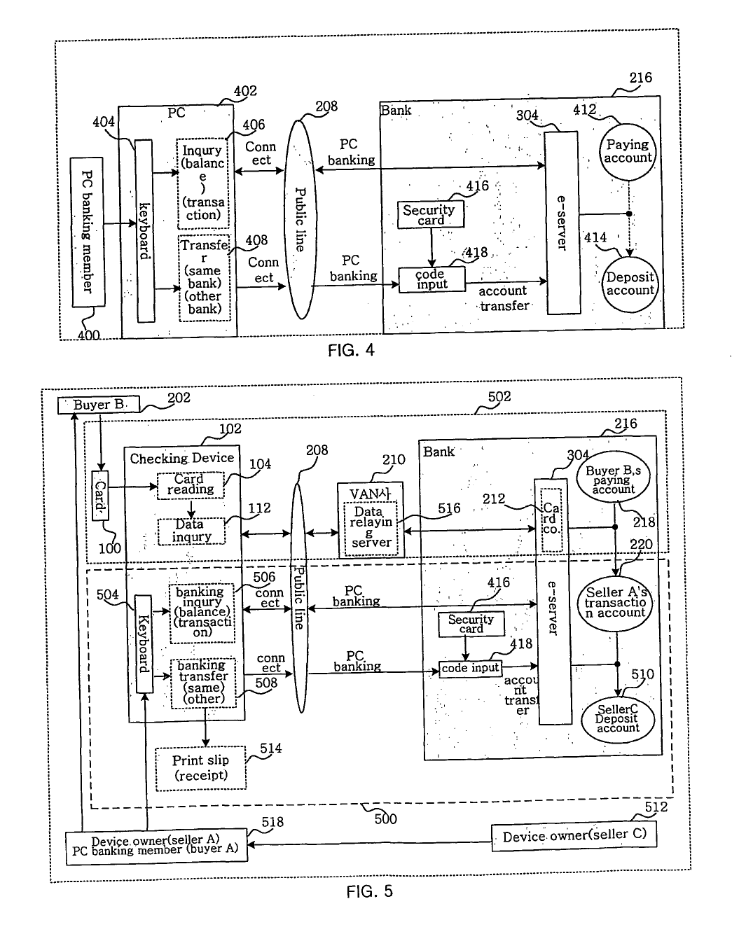

So in this process new security systems, which were ubablde in the former public line PC banking(FIG 4), is enabled in transfer.

Especially for printing(514), it is more evident with VAN engaging(FIG 6) than FIG. 5.

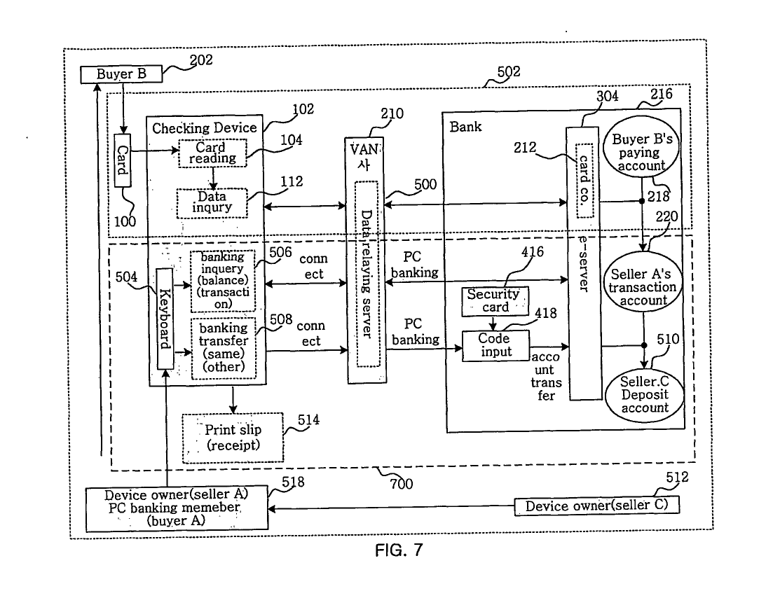

FIG. 7 is a schematic view for describing an electronic operation of a PC banking system in accordance with another embodiment of the present invention.

FIG. 7 shows the case which the card device(102) is connected to VAN server(516) with direct line.

In FIG. 7, the card checker(502) and PC banker(700) is available at the same time, so adding the PC banking ability to card check device does not interfere in credit card or direct card check.

But in FIG. 7, the role of VAN is much more greater than the FIG. 6

In FIG. 7, it is same that the owner(518) uses PC banking through VAN server(516) but the speed and safety is far better.

And the FIG. 7's example is different in terms of relation between VAN and the owner.

In FIG. 6 the owner's demanded PC banking and e-paying, but in FIG. 7 the VAN is demanding PC banking and e-paying.

Thus FIG. 7 is more VAN-centered than owner-centered PC banking and e-paying, that is to say.

In FIG. 7's example also the PC banker(700) starts with keyboard(504) instead of card(100), PC banking with bank(216) follows the process of check(506) and transfer(508) of his account(220).

And in this case the VAN server(516) is only helping the connection to bank server(304), and the transfer should be made through code input(418) in security card(416) by the owner(518)

Therefore the paying in PC banking is far more faster and safer in former cash paying.

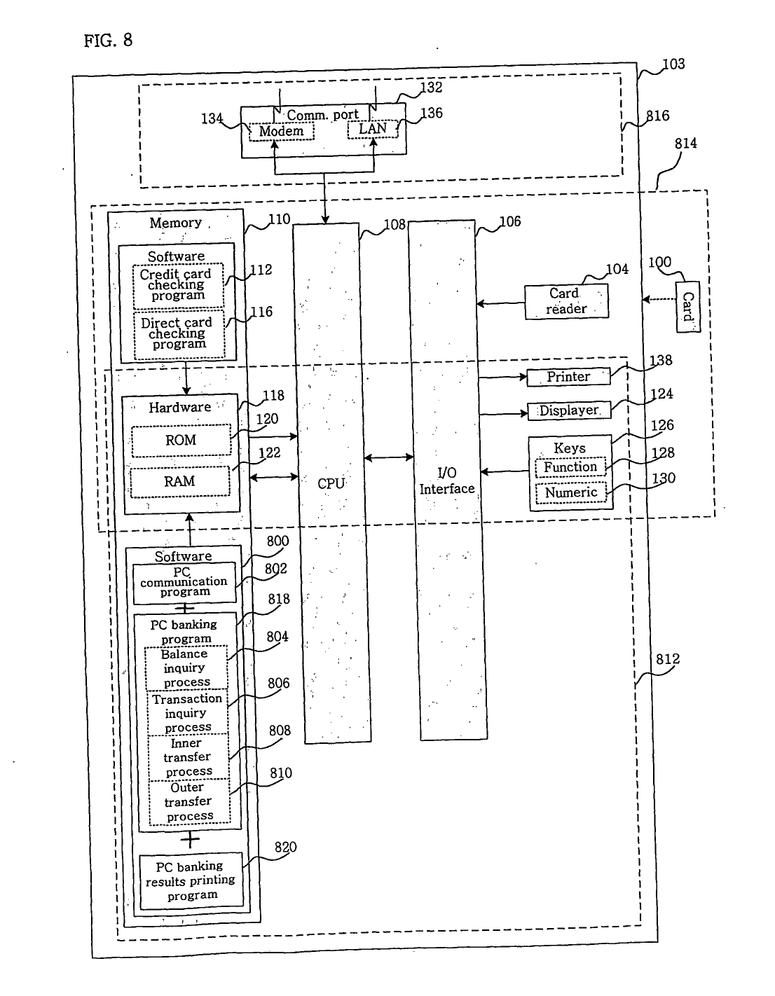

FIG. 8 is a schematic view for describing card check device which allows PC banking system of FIG. 5, FIG. 6 and FIG. 7.

As shown in FIG. 8, the card check device(103) is made of card reader(104), I/O(106), CPU(108), ROM(120) and RAM(122), display(124), key input(126), communication(132) and print(138). It is same with former card check device(102).

The card reader(104) is only used associated with card checker(502), and not used with PC banker(S00, 600, 700). PC banker(500, 600, 700) is activated by key input(130), not through card insertion.

And in terms of software, this device(103) has former card check program(112,116) and also PC communication program(802), PC banking program(818), result printing program(820) in its memory.

PC communication program changes the device(103) to PC through key input(130), communication part(132) connects to PC banking system in bank through modem or direct cable.

PC banking program includes, as shown in FIG. 8, PC banking account check routine(804), PC banking account performance check routine(806), PC banking inner transfer routine(808), PC banking outer transfer routine(810)

PC banking program helps the account check, account performance check, inner-transfer, and outer-transfer, in display(124) of width 16 letters and length 4 letters, using PC communication program(802).

And the result printing program(820) is also included to print the result through printing part(104) in card device. It is for evidence in PC banking.

The software ability in this invention recalls the PC character of the card device and reconstructs it to work as PC communication system(816).

With this method the card device can be transformed into many types, according to software.

The card device is sure to exceed former Apple in terms of hardware, but it is not enough to take much data required in these days.

So the minimum elements should be put in the memory chips of card device, and others should be placed in communication server.

Thus FIG. 8's card check device(103) has only minimum elements for PC communication its ROM and RAM.

And it is better to go through VAN server(516) than to go direct in public line when connecting to bank server(304).

Because it can easily download the software from VAN server. And considering the communication delay, it is faster to connect through direct line than public line.

FIG. 6 is a schematic view for describing an electronic operation of a PC banking system in accordance with other embodiment of the present invention.

As shown in FIG. 6, the card check device includes; body(600), CPU(604), OS(606), RAM(608), ROM(610), clock(612), password system(614), card reader(104), I/O(616), software(620), communication port(622), data reservoir(626), display(618) and print(628). And it connects to e-commerce company server(402), VAN server(406) or bank server(226).

Password system(614) may not be necessary component of this invention, because it can be substituted by CPU or software. But considering that card check device is a registered client in terms of hardware, it is best to apply it as much as possible to e-commerce. So it could become independent component.

And also the card reader(104) is not necessary, because the device(600) does not work through the card(102). But it remained for the case when the owner(200) takes the payment from his customers.

This invention's card check device(404) is activated through key input(602), not through card reader(104). Thus it can have many softwares in its RAM(608) and ROM(610).

And if the communication program is in it, it can share and exchange much information. Especially connection with outer server enables the card device(40) to exceed its physical limits.

And to use the device(404) as e-commerce device, it has PC communication program, PC banking program, PC ordering program, PC communication result printing program, apart from former card check program(124).

In here PC communication program transforms the device to PC communication device through key input. PC ordering program connects to e-commerce company server(402) and PC banking program connects to bank server, giving the device ability to order and transfer.

In here it is estimated to put the program within check device(404), but the connection to outer server is needed because its PC ability is limited.

For example, it is hard for check device to display the results, within the screen size of width 16 letters and length 4 letters. So the server system connected to check device can control the display, and the program in the device will be reduced.

And the same logic is applied to data saving. So the system construction of check device(404) should be made of outer server devices. And using it when needed. This construction is also true to printing process.

And this invention allows the card device(404) to perform as PC communication device, reconstructing the PC system of the device. And the device can transform into many types, according to software construction. Even to another device, which has more ability than the e-commerce device we've been talking about.

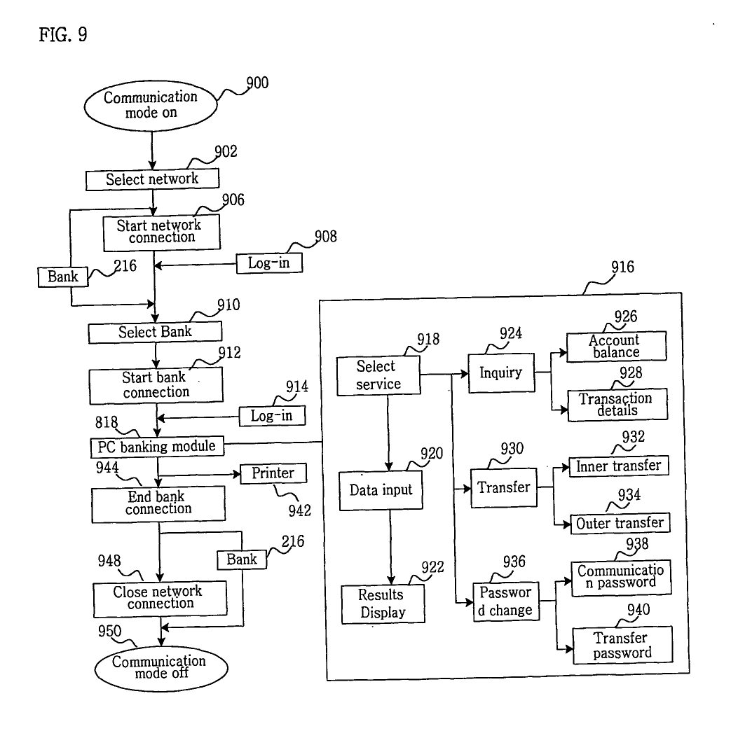

FIG. 9 is a flow chart for explaining the operation of PC banking system according to this invention.

To use PC banking, the check device should be set up to communication mode(900).

This is enabled by the keyboard input. After the communication mode is set, public line or VAN line or bank line is selected(902), connected(906), and the device takes the log-in(908) process.

If the line is bank's, the connection(906) and log-in(908) process can be excepted.

After the log-in, the bank is selected(910) and connected(912), the process of log-in(914) is taken for PC banking.

After log-in, PC banking routine(818) differs to which PC banking the owner wants. Its subroutine(916) differs to whether the service selection(918) is check(924) or transfer(930) or password change(936).

In check, it differs whether it is account check(926) or account performance check(928). The display input(920) and the display output(922) is different.

In password change, it differs whether it is communication security code change(938) or transfer password change(940). The display input(920) and the display output(922) is different.

After the service, it shows display input and display output, and print(942). If not, it ends the bank connection(944), ends the line connection(948), ends the communication mode.

And if it is direct connection, then the middle process is excepted.

After the ending of communication mode, the check device has same function as the former card device.

FIG. 10 is an account check routine of PC banking system shown at FIG. 9.

If the service is selected as account check(926), the input(1002) and the output(1006) follows. The input is account number and password.

And the output(1008) is account number, current money, account owner, last date, the time. The contents are fixable according to display condition.

FIG. 11 is flow chart of account performance check routine(1100) from PC banking routine shown in FIG. 9.

If the service is selected as account performance(928), it is same to go through input(1102) and output(1106).

But the input(1102) is different, as start date and end date is added.

And the output(1108) is different, as daily money input and output is added.

FIG. 12 is inner transfer routine(1200) of PC banking routine shown in FIG. 9. It is more complicated because it follows the process of input of security codes(418) in security card(416).

After the code input, the transfer input(1206) and output(1210) is followed. Then printing(1214).

In case of inner transfer, the input is destined account number, account password, starting account, amount, and the transfer.

Input is printed(1212), including input and transfer amount, transfer fee, the receiver name.

Output is printed(1216), including the input(1212) and date, account owner name, destined account owner, inner-performance number.

FIG. 13 shows flow chart of outer transfer(1300), from PC banking routine shown in FIG. 9. If outer transfer is selected, the security code(416) in security card(416) is needed, and follows the confirmation(1308) by display. And then the transfer and printing(1312) is followed, same as inner transfer shown in FIG. 12.

But in case of outer transfer, the destined bank code(1310) is added. It is also printed(1314) in result with input bank name, bank number and subject connection for security.

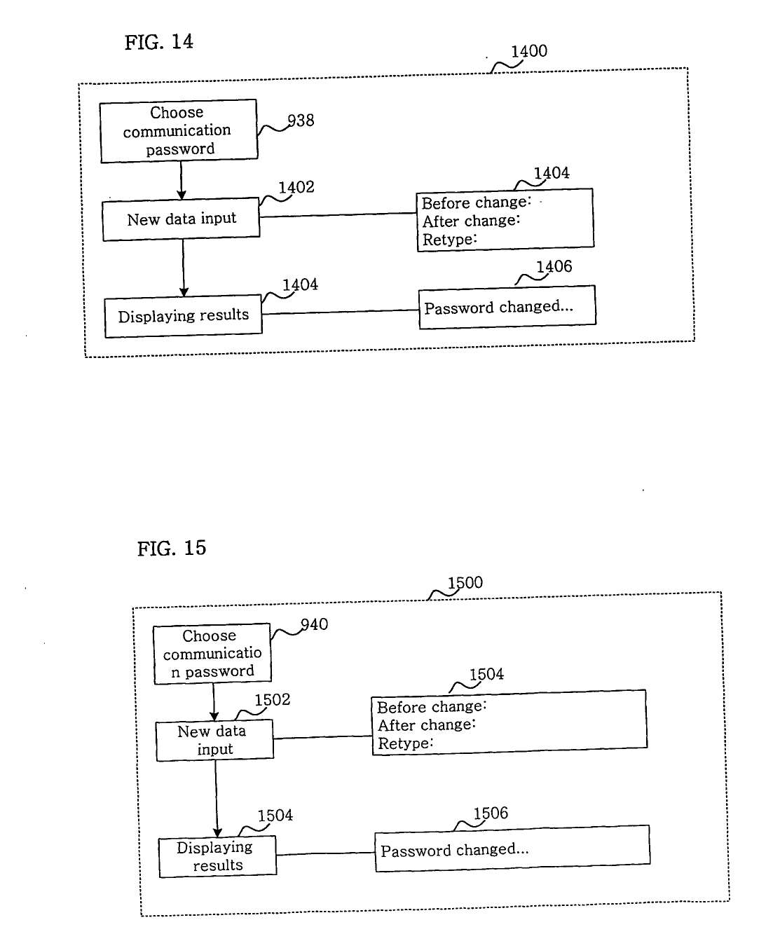

FIG. 14 is communication password change routine(1400), from PC banking routine shown in FIG. 9.

If the communication password change(938) is selected, change input(1402) and change output(1404) is followed. Input elements(1404) are password(before), password(after), and repeat. Output elements(1406) are confirmation.

FIG. 15 is flow chart of transfer password change routine(1500) shown in FIG. 9. IF the transfer password change routine(1500) is selected, also input(1502) and output(1504) follows. And the input elements(1504) and output elements(1506) is same as shown in FIG. 14.

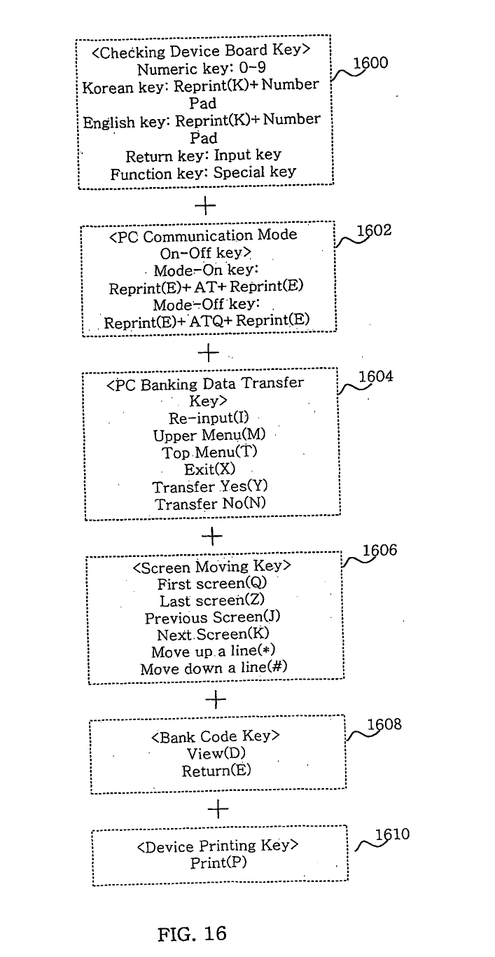

FIG. 16 is construction of key control of card device, following the example of this invention. There was no key for communication in former card device's key control(1600). Only the number and function key were available and the korean and english letters were put through number key.

So this invention changes the former key construction and adds a few combinations. If the number keys are combined, there might be problem in PC banking in taking numbers. So it is better to combine function keys and letter keys.

To activate this invention, many more key setup is needed, which the former card device does not have.

As shown in FIG. 16, card device's key construction following this invention is made of; former key(1600), communication setup(1602), data transfer (1604), display moving (1606), bank code (1608), print (1610). communication setup(1602) is for PC communication, on and off is available. Data transfer(1604) is for data exchange with bank server, and has re-input(I), up menu(M), start menu(T), end(X), transfer confirmed(Y), transfer denied(N). Display is to overcome the limit of device's display, which Is width 16 letters and length 4 letters. It has start screen(Q), end screen(Z), back screen(J), front screen(K), up one line(*), down one line(#).

Bank code(1608) is for outer transfer, and has view(D) and return(E).

PC banking results printing is different from former card device's printing. So the other print(1610) key is needed. It has print(P).

FIG. 17 is construction of PC banking connection, following this invention. And the special display construction is needed, since the check device's display is limited to width 16 letters and length 4 letters. In this PC banking connection display, sub menus are only selectable through number key, and input, output is strictly limited.

Through PC communication key shown FIG. 16, the communication mode opens. And line selection(1702) display(124) is on, as shown in FIG. 17. And the public line(208), VAN line(210), bank line(216) is selectable, through “1”, “2”, and “3”.

If the public line is selected through “1” key, connection selection(1704) display(124) is on. And the owner selects the connection with number key, login display(1706) is on. And with the ID and password input, bank selection display(1708) is shown, followed by bank login display(1712). The movement of display(124) is needed in here because so many banks can't be shown in one screen.

So the bank selection display(1708) should show screen moving key(1710).

After the login process in login display(1712), service selection display(1714) is shown, in order for owner to do PC banking.

And in the service selection display(1714), transfer, check, password change is selectable through number key, and the each display follows(1716, 1718, 1720). If the movement of screen is needed then key(1711) such as “Q”, “Z”, “K”, “J” can be used.

If the VAN is selected by pressing “2” in line selection display(1702), the VAN login display is on(1722). With the ID and password, bank selection display(1724) is on.

This is same with public line. In this invention the VAN login(1722) is followed by bank login(1712), and it is better if VAN provides other services.

If the bank line is selected by pressing “3” in line selection display(1702), the bank selection display(1726) is on directly.

And it is same with public line, bank connection display(1726) followed by bank login display(1712).

FIG. 18 is construction of input, output display following this invention. As shown in FIG. 18, keys like transfer, screen moving, print, menu moving is on one side of screen, along with input and output elements.

This is to do away with inconvenience with small screen.

As shown in FIG. 18, account check is selected with “1” key in check code selection display(1716). And with the account number and password input(1800), account number, owner, last used date, current date is shown in output display(1802).

And account performance check is selected with “2” key in check code selection display(1716). And with account number, password, start date, end date input(1803), account number, money, owner, input and output, current date is shown in output display(1804).

And inner transfer is selected in transfer code selection display(1718) with pressing “1” key. Code number input display(1808) and account number, password, destined account number, transfer amount, subject, transfer password input(1810) is needed, followed by account number, destined account number, money, transfer fee, subject, name confirmation shown in output display(1812).

And in this case with “P” key, date, account number, destined account number, owner, subject, money, trasnfer fee, perfromance number is printed in printing part(138).

And outer transfer is selected in transfer code selection display(1718) with pressing “2” key. Code number input display(1808) and account number, password, bank code, destined account number, transfer amount, subject, transfer password input(1816) is needed, followed by account number, bank, destined account number, money, transfer fee, subject, name confirmation shown in output display(1818).

With “D” key in input display(1816), bank code display(1818) is on.

And in this case with “P” key, date, account number, bank, destined account number, owner, subject, money, transfer fee, performance number, bank number, subject connection is printed in printing part(138).

And with “1” or “2” key, communication or transfer password change is selected. Then before password, after password, repeat input(1824) and confirmation display(1826) follows.

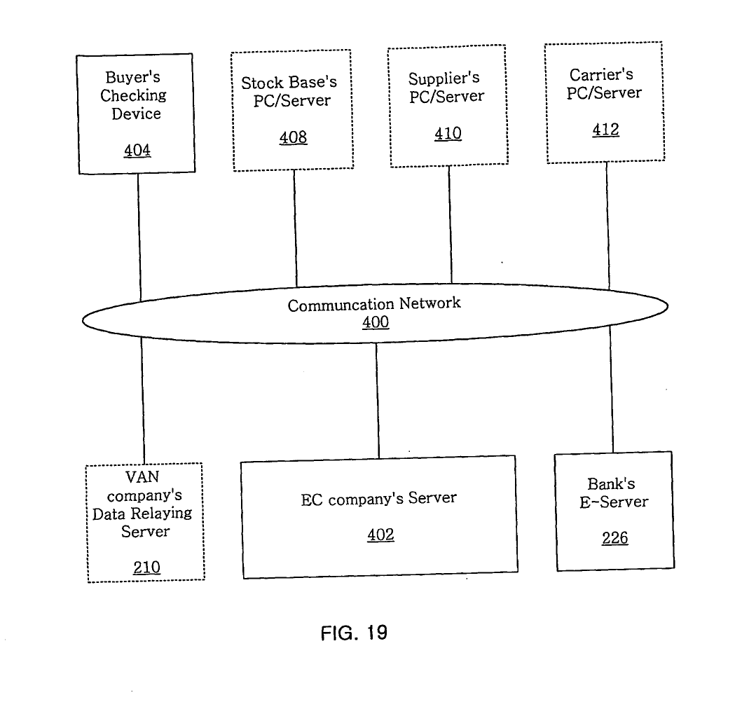

FIG. 19 is a schematic of system block of e-commerce system following the example of this invention. The elements for this invention, like server(402), card check device(404), VAN server(210), circulation base server(408), producer server(410), delivery company(412) and bank server(226) connected through communication line(400). The communication line can be public line, direct line, cellular, PCS, microwave, or satellite line.

And this invention can work with only server(402), card check device(404), bank server(226). But with addition of VAN server(406). circulation base server(408), delivery company server(410), producer server(410) it can be much more powerful.

And here the basic elements means a tool for specific economic subjects, and it can be one or more.

Especially the card check device forms network, connected with many device and server.

Relation between supporting elements and server needs this kind of interpretation. VAN server and card device already forms network. It is recommended that bank server and other elements to form network.

And circulation base server, which is key element in real time delivery, should not necessarily be under control of e-commerce company, provided that it is in the network.

So the delivery company or circulation base can be used with no change. But packing, delivery should be under the control of e-commerce company. It can run circulation server or confirmation server when needed. Thus server can be separated, and not necessarily be fixed in one place. Support elements are addable in time to time, and in extreme case it is possible to form network among buyers and sellers.

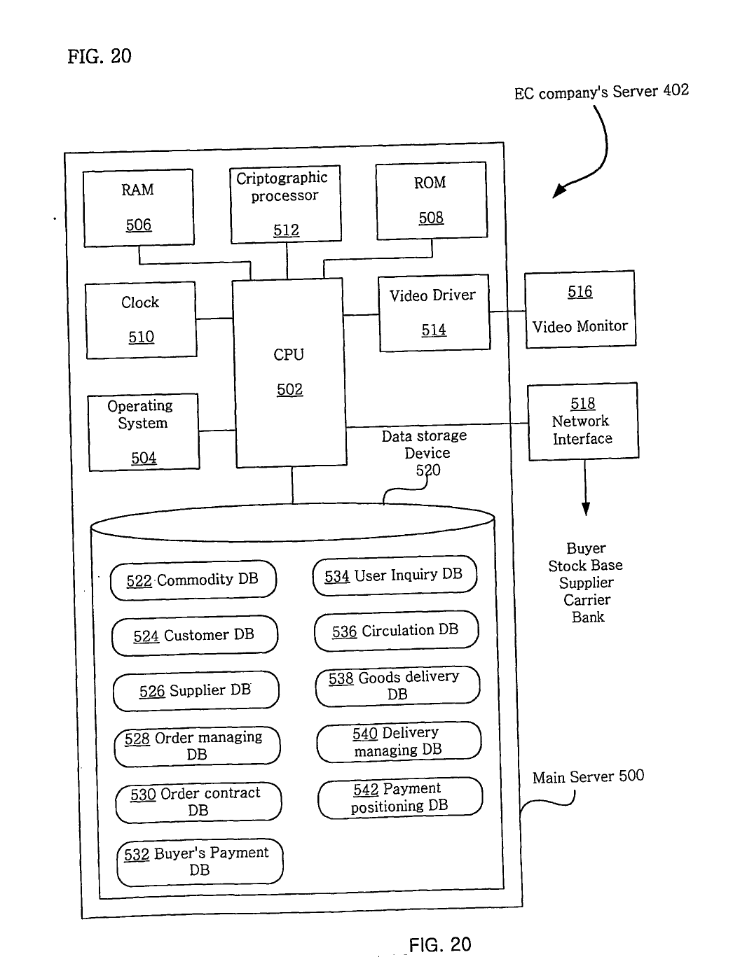

FIG. 20 is a schematic view of e-commerce company's server system block following the example of this invention.

As shown in FIG. 20, e-commerce company server(402) includes CPU(502), password system(512), RAM(506), ROM(508), OS(504), network interface(518) and data saver(520). Server(402) can be one or more combination of computers, work stations or super computer, provided that it has sufficent memory and processor. CPU(502) can be either Intel 100 MHz FIG. 54C or Motorolla 120 MHz PowerPC 604 or SUN MICOROSYSTEM's 166 MHz UltraSPARC-I.

Password system can be MC68HC16 micro controller. Password system supports confirmation of buyer, bank, producer and delivery company, and makes anonymous deal possible.

Password system(512) can be software-controlled or included in CPU(502). Others like VLSI technology's 33 MHz 6868 or Semaphore Communication's 40 MHz Roadrunner 284 can be commercially used.

And in FIG. 20, the data saver can be CD-ROM or flash memory as well as hard disk. Data saver(520) has information DB such as product(522), customer(524), producer(526), order management(528), order contract(530), buyer payment(532), buyer check(534), circulation(536), delivery(538), delivery control(540) and confirmation control(542). In order to create and control these data bases, the software like Oracle7 from Oracle corporation can be used.

Product information DB is composed of; product code, product name, price, produced price, selling price, produced amount, left amount, sold amount, product elements, product picture, product delivery condition, delivery schedule, product produced address, address number, circulation base name, e-mail, and confirmation condition. And this product information DB(522) is normally made by e-commerce company. But with notice the producer can also build it in through network connection.

And the product information DB(522) is different from time to time following kind, left amount and circulation base's condition.

So in this invention the real time delivery means reducing of delivery time and checking of delivery schedule and condition.

And the method is e-commerce company's control of circulation base, with real time PC checking of left, entering, sending, delivery and completion. And in every case of delivery, the schedule is confirmed and checked real time by an hour.

Customer information DB(524) is built separately, in case of individual and company.

But here the customer is card check device owner. So the ID, password, owner number, store name, address, address number, national code, bank, check device type, device number, membership number, job code, phone, FAX, cellular, e-mail and homepage.

And each information is built by individual customer both when he registers and orders.

Producer information DB is built from contract with other companies. It differs whether the company is delivery company or producer.

If the company is producer, the DB includes ID, password, e-mail, code, company number, name, address, zip code, owner name, national code, confirmation condition, bank, account number, part code, phone, FAX, homepage, person, reach phone, cellular, reach e-mail.

If the company is delivery company, the DB includes ID, password, e-mail, code, company number, name, address, zip code, owner name, national code, confirmation condition, bank, account number, transfer fee condition, phone, FAX, homepage, delivery schedule, base name, base address, base zip code, person, reach phone, cellular, reach e-mail.

This DB is normally built by e-commerce company with help of the companies, but some parts can be built by themselves through network.

Order control DB(528) is automatically formed, according to product information DB(522), customer information(524), producer DB(526). And it is extra DB for controlling and answering customer's order, fast and clearly.

Order control device DB(528) includes time, date, number, ID, code, name, price, amount, money, receiver, receiving address, e-mail, delivery schedule, company code, company ID, producing price, ordered amount, left amount, confirmation condition, bank, account number, reach person, reach phone, FAX, delivery company ID, delivery address, zip code, base name, base address, base zip code, fee condition, delivery company confirmation condition, deliver company bank, delivery company account number, delivery company reach person, delivery company e-mail, delivery company phone, delivery company FAX.

And the ID, amount, address, zip code is formed form order, and rest are automatically formed information device(522, 524, 526) mentioned above.

These elements seems to pile up, and it looks like so much of data.

But it is controlled by product code and company code, it is not much of data without the change in these codes or customer input.

So it is only order number, ID, product code, company code, ordered amount, price. Speciality of order control DB(528) is that the order control code is formed from order number, and it works with transfer code including price and control code. Thus the order contract code is made and vanished.

Order contract DB(530) is formed when server cannot make any more of transfer code. It is for order confirm and order performance according to customer and e-commerce subjects. It includes; customer contract information DB which is to order, confirm and perform, producer contract information DB for product, delivery company information DB which is for quick and stable delivery. And each DB differs to its objective.

It is automatically formed by the server without any outer input.

Let's see the components of each DB. Order contract information DB includes date, time, ID, product name, amount, price, money, delivery schedule, receiver, address, zip code, e-mail, phone, cellular, deal code(order control code), transfer code(transfer control code).

Producer contract DB includes date, ID, product code, amount, money(price*amount), address, zip code, base name, base address, base zip code, delivery schedule, produce code, reach person, reach e-mail, reach phone, reach cellular, FAX, confirm condition, bank, account number. Delivery company contract information DB includes date, ID, delivery code, delivery unit, delivery schedule, reach person, reach e-mail, reach phone, reach cellular, FAX, confirm condition, bank, account number, fee condition, address, zip code, base name, base address, base zip code, receiver, receiving address, receiving zip code.

Customer payment control DB(532) is formed after transfer confirmation of customer from order contract information DB. It includes contract date, ID, account number, transfer amount, transfer code.

Customer check control DB(534) is for checking contracts performance of customer, and formed from bank account check. It include date, ID, account number, money, transfer code.

About delivery, the delivery unit and amount differs to the product. Thus in this invention the e-commerce company runs the circulation base and controls the product's packing, sending. And it only uses delivery company in last process. Then it is possible to assembly all the different delivery condition and schedule in one circulation base. And real time delivery is possible. Left confirm, delivery capacity confirm, emergency delivery is also possible.

It is also possible to separate direct delivery, re-packing delivery, and delivery company-needed delivery according to product condition and delivery schedule. And e-commerce company need not necessarily run the circulation base. It can rent one from delivery company. Furthermore reducing of the left from real time checking of delivery can bring a lot to e-commerce.

It is rare to form real time contract with producer and delivery company. And it should be treated differently from customer condition.

But in this invention in order to show that the confirmation of producer and delivery company is possible in e-commerce company's bank transfer, these and bank account was treated as one unit.

And it is also acceptable for bank to form separate account with producer and delivery company and do the real time transfer in every order.

Circulation information DB(536) is formed for better circulation. It includes base name, base address, storage information, delivery means, delivery time, packing method, product code, input amount, output amount, left amount, person, e-mail, phone, cellular, FAX.

Delivery information DB(538) is formed after the customer's confirmation, and automatically made from contract information. DB(530), circulation DB(536). It includes date, ID, produce code, product code, product amount, address, base name, receiver, person, e-mail, cellular phone, FAX.

Speciality of this DB(538) is that it is only temporary DB. That means it forms to help delivery and vanishes when delivery is completed.

Delivery control DB(540) is automatically formed from comparison between customer payment control DB(532) and customer check control DB(534). It includes date, delivery time, ID, code, amount, producer code, address, delivery company code, base name, receiver, receiver address, person, e-mail, phone, cellular, FAX, delivery order step, producer step, delivery step, delivery complete step, and confirmation step.

Confirmation control DB(542) is formed for confirmation of the deal by server. It is formed from comparison between customer payment control(532) and customer check control(534) and delivery control(540) results. It includes date, content, code, payment, paying, and etc.

Network interface(526) is communication gateway to customer, producer, delivery company, bank through card check device(404), producer PC(410), delivery company PC(412) and bank server(226).

Former mode, LAN card can be used as network interface(445). Network interface(445) can be connected to internet and/or America Online, CompuServe, and Prodigy.

This example shows the server to be one computer, but it can be separated to several computers.

In one example, the server(402) is separate structure and data base and processor is housed in different system and place.

These computers are connected to herb or switch that acts as communication link. This system is less sensitive to disasters that effects whole system, and more active and changable.

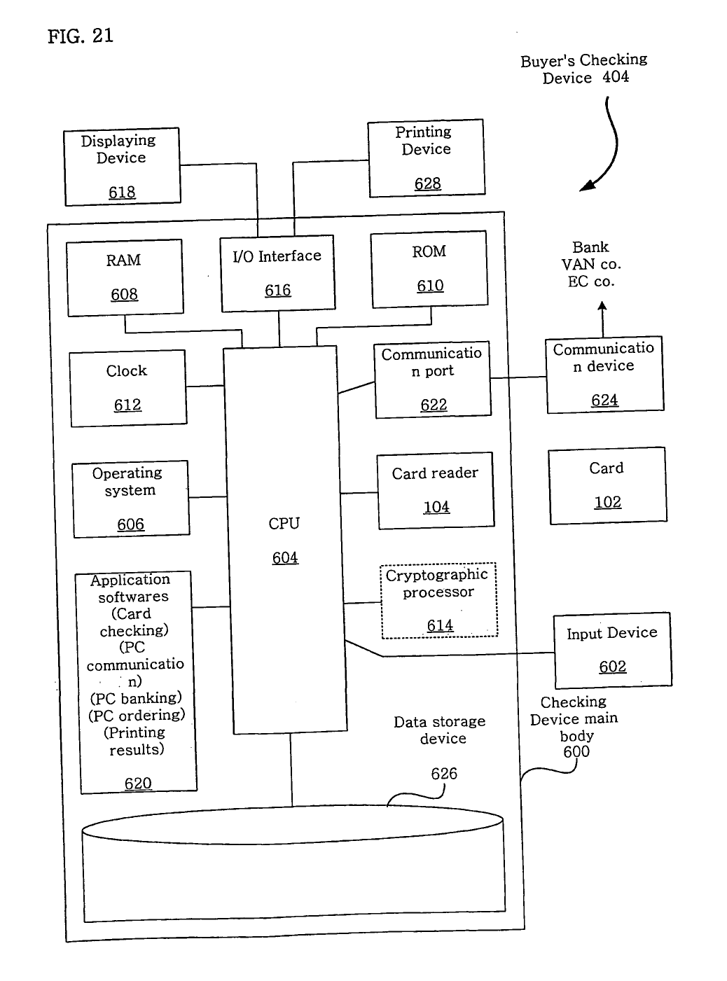

FIG. 21 is schematic view of buyer check device's system block following the example of this invention. Circulation base PC(408) includes CPU(704), RAM(708), ROM(710), input device(702), video activator(716), video monitor(718), clock(712), password system(714), communication port(720), communication system(722) and data saver(724) and interfaced with e-commerce company server(402).

B2B e-commerce which uses check device as line should run circulation base PC(408) as server for various customer demands. And PDA, cellular phone, PCS phone, and pager can be used along with PC

And the data system used in here is hard disk, CD-ROM, flash memory. Example of DB is; product information(726), circulation information(728), delivery information(730), delivery control information(732), message(734). And the Oracle7 from Oracle Corporation is used.

DB components in circulation base PC is shown in FIG. 19.

FIG. 21's product information is controlled by server, so the base PC is only a check device in the process.

Circulation information DB(728) is also automatic DB from FIG. 19's circulation DB(536). It includes date, schedule, delivery means, delivery time, packing method, product code, input amount, output amount, left amount person, cellular phone, and phone.

And this DB is also controlled real-time, and base PC is limited in its data input. Real time check device is formed according to order-perform process.

FIG. 21's delivery information DB(730) is also automatically formed from FIG. 19's delivery information DB(538). It includes ID, producer code, product code, amount, address, receiver, receiver address, person, e-mail, phone, cellular, and FAX.

This DB(730) is temporarily formed and vanishes after delivery is completed. This DB is not fixable from base PC.

FIG. 21's delivery control information DB(734) is also automatically formed from FIG. 19's circulation control DB(540). It includes ID, producer code, product code, amount, address, receiver, receiver address, person, e-mail, phone, cellular, FAX, delivery order step, producer step, delivery step, delivery completed delivery, and confirmation step.

FIG. 21's message DB(734) is composed of real time order/confirm/perform between e-commerce server and circulation PC.

Components are product information B(726), circulation DB(728), delivery information(730), delivery control DB(732) and changed e-mail, phone, and transfer code.

These data DB(734)s are normally sent through e-mail from e-commerce company's server, but sometimes shared through web page construction.

Especially in B2B contract the server(402), producer PC(204) and delivery company PC(206)'s share of DB through web page is essential.

Producer PC(204) and delivery company PC(206) can be composed same to card check device(114).

But the DB components differs, because the role of producer and delivery company is different.

Producer PC(204) has DB of; date, product name, price, amount, money, place, base name, delivery condition, produce code, person, e-mail, phone, cellular, FAX, bank, account number. Delivery PC(206) has DB of delivery code, base name, address, delivery unit, delivery amount, receiver, receiver address, person, e-mail, phone, FAX, bank, and account number.

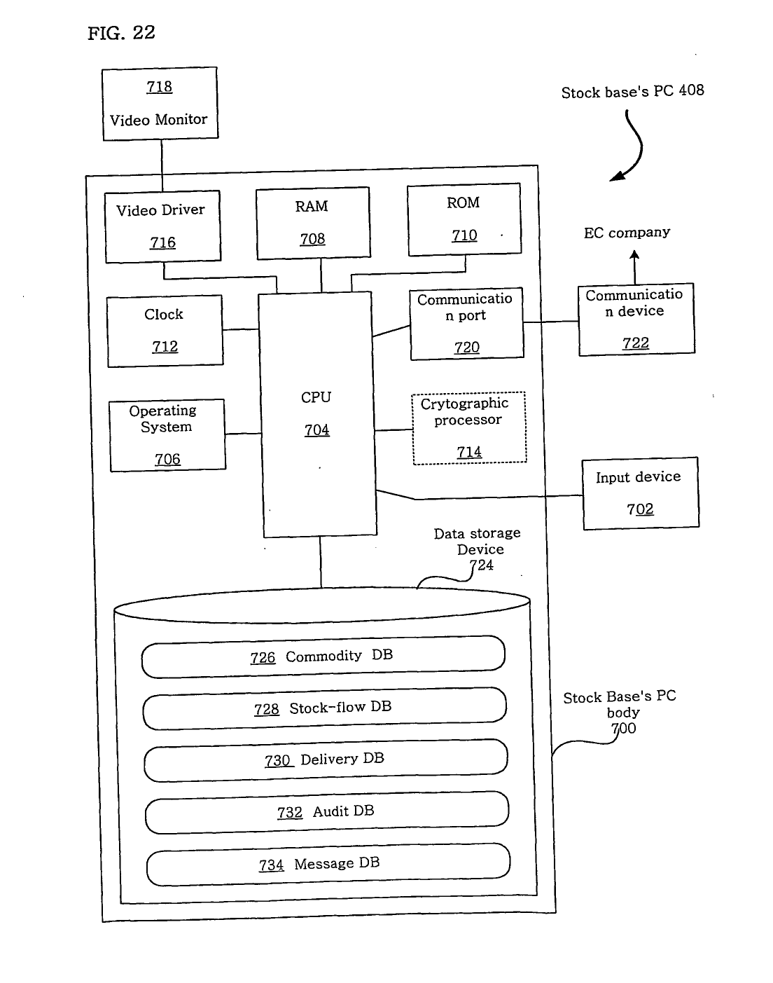

FIG. 22 diagram of VAN e-commerce method following the example of this invention.

The former card device's functions remain in FIG. 22. So from the card reader(802) through VAN(209) server(210), the check device(404) connects the bank(216) e-server(226).

But in e-commerce system(804) there's no VAN(209) sever(210), different form card reader(802). In FIG. 22's e-commerce system, check device(404) directly connects the B2B server(402) in e-commerce company(814) through line(400) and connects the bank(216) server(226) to check(810) or transfer(810).

In FIG. 22's e-commerce system(804) the owner A(806) takes step of, i) connects to e-commerce company(814)'s B2B server(402) through product order program(812) in check device(600) and pick, order the product ii) to confirm the contract, call the transfer(810) program in check device(600) and connect to bank server(226). Then input the code(312) in security card(310), and transfer from his account(220) to company's account(824).

And it is also possible to check the owner's account through check program(808).

The e-commerce company server(402) prepares for order of owner A, at the same time checks for confirmation of contract. And it checks for payment in company's account through bank server(226). If the payment is checked, then it organizes circulation base(816), producer(822), delivery company(820)'s PC(408, 412, 410) to deliver the product. And after the delivery is made, the owner confirms it to e-commerce company through circulation base. Then company server connects the bank server(226) to transfer money to producer and delivery company account(826, 828). Of course this process includes code input(312) in security card(310). And the real-time e-commerce ends. Server's movement are shown in FIG. 39.

FIG. 22's construction, which adds PC banking ability to check device, can give a lot to e-commerce. First of all the fee is not needed. And the check and transfer are possible in real-time, through PC banking ability of check device.

More important thing is that like FIG. 22's transfer, check device's ability of transfer can act as payment for every product and finance contract.

This means much expansion of space for cash without cash itself. Check device owner or PC banking member can pay through the device in any time or place.

And also it will activate e-commerce more, with PC banking. There was problem that payment method should be in e-commerce server.

So the card number should be left in server, and it was evidence for contract. Even after the contract it was kept for evidence. It was structural contradiction.

But this problem is under the condition of; the company is creditable and does not have any possibility of discredit.

But many e-commerce company's are not very creditable, thus it is very risky for card numbers to be kept in company.

And even the password was known to be cracked so easily, so it had much of security weak point.

So e-commerce was not easy to develop, and it has much hazards.

In this invention the bank's e-finance system is used for payment. So there is no case for payment method information left over in server.

And the bank system is more safe. Because it has security code(418) in security card(416) and the contract is checked before and after. It is far more safer than former payment security of e-commerce. It is too much for e-commerce company to build security system that exceeds bank's.

And the economic value that is enabled by this invention is very great.

The owner can order and sell the product within his place. And this means easier price comparison, more chance for profit, more time for producing.

So the owner's ability is increased. Considering every device owner in whole country, it is very great increase in value producing, even without other elements.

Card device has evidence of printed material in card company or bank. It can ask for a check with credit card. And the other print materials can work as evidence. There is nothing for evidence in individual PC banking. But the device makes it possible. It's same for the e-commerce. Registered device can provide evidence. This evidence ability is very important in making creditable e-commerce.

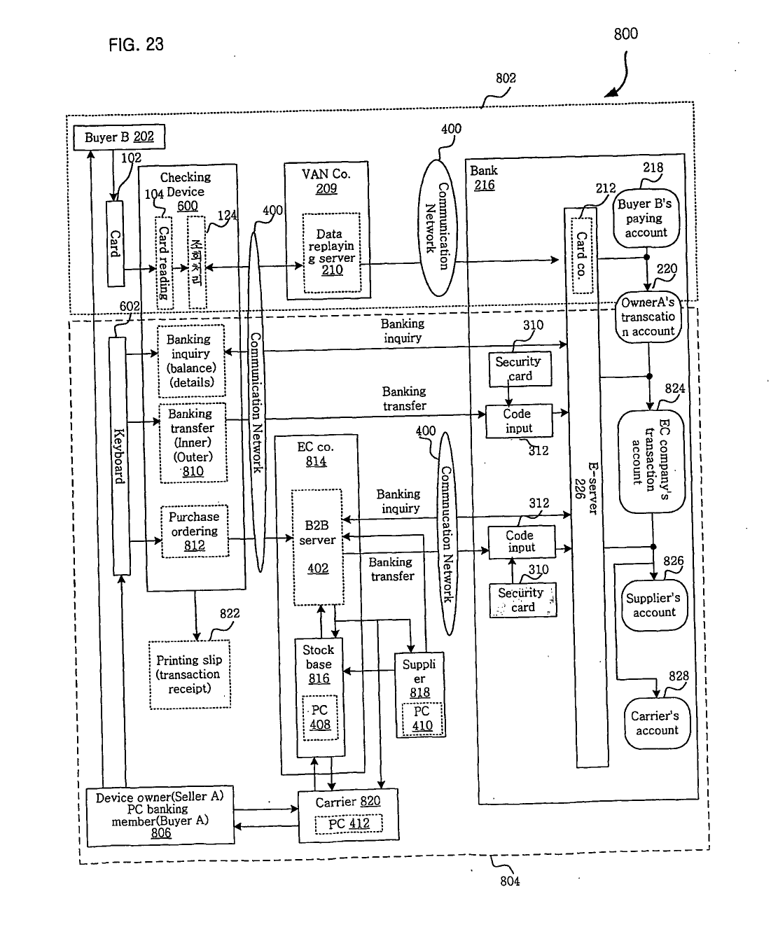

FIG. 23 is a system performance diagram of VAN associated real-time e-commerce's process following the example of this invention. FIG. 23's construction different form FIG. 22 for the VAN company interferes in PC banking. It looks simple technologically but has important meaning in business.

That is FIG. 22 is composed under the condition that VAN and e-commerce company has strategic relation

But in terms of business strategic relation cannot form stable partnership.

So for the banking system in check device to be base for real time e-commerce, VAN should be encouraged for PC banking in check device. FIG. 23 is a suggestion for that method.

In FIG. 23 the former ability of card device is kept just like FIG. 22. As shown in FIG. 8, check device(404) connects to bank(216) server(226) through VAN(904) server(906) in card reader(802).

But in e-commerce system(902) it is different from FIG. 8. In case order, check device(404) order the product through e-commerce company(908)'s B2B server(402) by public line. In case of confirm, the check device connects the bank(216) server(226) through VAN(904) server(906) to check(808) or transfer(810).

In FIG. 23's e-commerce system the owner A takes process of; i)order the product through keyboard(602) by e-commerce company(908)'s B2B server(402), using ordering program(812) of the check device(600). ii) to perform contract, he connects bank server(226) through VAN(904) server(906) and takes process of transfer from his account(220) to company account(916) by input of security code(312) in security card(310). And the owner(806)'s real time contract ends.

The owner can check his account through check program(808) before transfer(810) through bank server(226).

The e-commerce company server(402) prepares for order of owner A, at the same time checks for confirmation of contract. And it checks for payment in company's account through bank server(226). If the payment is checked, then it organizes circulation base(816), producer(822), delivery company(820)'s PC(408, 412, 410) to deliver the product. And after the delivery is made, the owner confirms it to e-commerce company through circulation base. Then company server connects the bank server(226) to transfer money to producer and delivery company account(826, 828). Of course this process includes code input(312) in security card(310). And the real-time e-commerce ends. Server's movement are shown in FIG. 39.

FIG. 23's construction upgrades e-commerce in many ways, better than FIG. 22. With VAN in position of middleman the check device becomes perfect payment for e-commerce. And this invention's e-commerce system becomes real-time e-commerce including card and PC banking.

And FIG. 23's construction was built under the assumption that the other e-commerce subjects like bank, department, circulation company would invest.

So the live information about demands can directly applied to supply in department or circulation company, and with bank's support of finance, the check device can become a model for live e-market. And with this organized as network, its social effects will be unimaginable.

And with cooperation of e-commerce server(402) and VAN server(906), the program construction of the check device(600) will be minimized. The check device will have simpler key construction and with right display arrangements the check device can become powerful PC communication system.

It will be much better if server can provide services like in-out put arrangements and saving.

And the security problem in data transfer will be solver, and evidence ability by printing will be added.

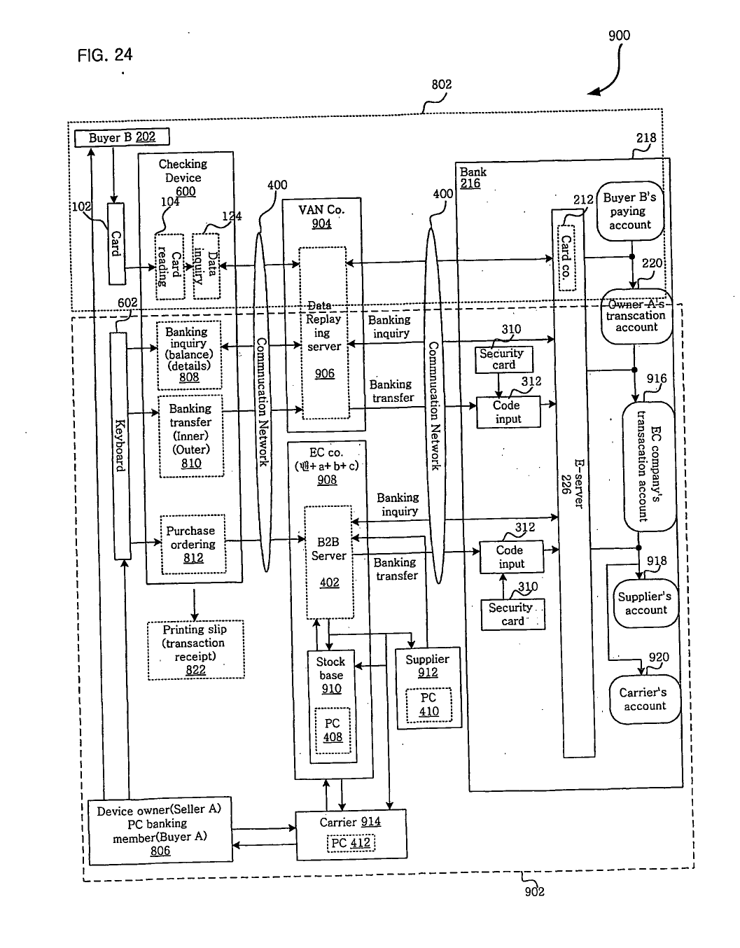

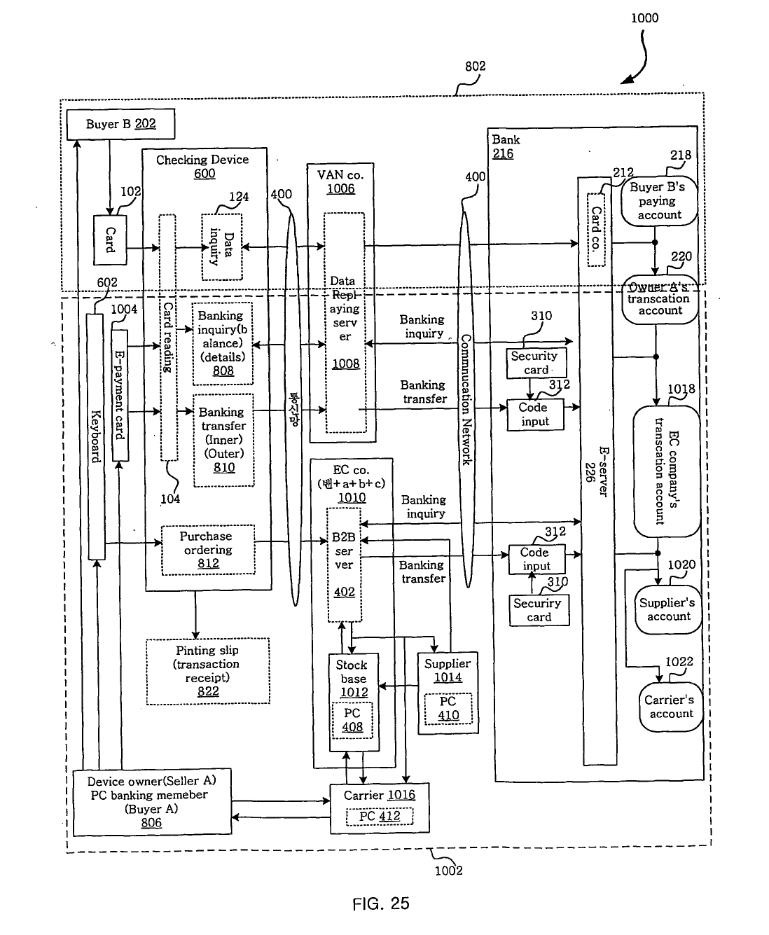

FIG. 24 is system performance diagram of co-invested real-time e-commerce process following the example of this invention.

FIG. 24 shows PC banking routine and e-finance card(1004) from FIG. 23.

And this will be needed by upgrading of e-card and customer's demands, in sooner or later.

E-card has credit card ability, along with former direct card ability. So it will soon take place of direct, credit, IC card market.

In FIG. 24, the card check device's former ability remains, same with FIG. 22, FIG. 23.

So in card reader(802) the check device(404) connects bank server(226) through VAN(904) server(906) to check or transfer.

But the e-commerce system(1002) is different. The check device orders directly through public line(400) by e-commerce company(1010)'s B2B server(402). It confirms through bank server(226) and VAN(904) server(906) to check(808) or transfer(810).

In FIG. 24 the e-card is activated in PC banking process, different from FIG. 22, FIG. 24.

In FIG. 23's e-commerce system the owner A takes process of; i)order the product through keyboard(602) by e-commerce company(908)'s B2B server(402), using ordering program(812) of the check device(600). ii) to perform contract, he connects bank server(226) through VAN(1006) server(1008) and takes process of transfer from his account(220) to company account(916) by input of security code(312) in security card(310). And the owner(806)'s real time contract ends.

The owner can check his account through check program(808) before transfer(810) through bank server(226).

The e-commerce company server(402) prepares for order of owner A, at the same time checks for confirmation of contract. And it checks for payment in company's account through bank server(226). If the payment is checked, then it organizes circulation base(1012), producer(1014), delivery company(1016)'s PC(408, 412, 410) to deliver the product. And after the delivery is made, the owner confirms it to e-commerce company through circulation base. Then company server connects the bank server(226) to transfer money to producer and delivery company account(826, 828). Of course this process includes code input(312) in security card(310). And the real-time e-commerce ends. Server's movement are shown in FIG. 39.

FIG. 24 is reformed version of FIG. 23's construction.

FIG. 22's disabilities are supplemented, and e-card makes much wider full of users to use the device.

Former e-card was payment method for product, so it was not much different from direct card.

But in this invention combined with the check device it can do check and transfer. And the activation of the device as PC banking system is very important in widening of users. And it will effect much in former card market if co-invested e-commerce company comes up with new e-card.

FIG. 39 is beyond FIG. 23 and FIG. 24, and VAN undertook the e-commerce company. Many VAN will consider this alternative if they see the power of FIG. 23 and FIG. 24.

But this idea is not the best idea, at least in terms of business. The VAN is no expert in e-commerce, and many producers will go out, there will always be possibility of supply overload if the check device market is not checked throughly. But it is certain that the technological values are great when they were merged together.

In FIG. 39, the former ability of the device remains, same with FIG. 22, FIG. 23, FIG. 24. In card reader(802), the device(404) connects bank(216) server(226) through VAN(1104) server(1105) to check card(credit/direct)s. But in e-commerce system it is different, In ordering, the device(404) connects e-commerce company(1108) B2B server(402) through public line(400) to order. In confirmation the device(404) connects bank(216) server(226) through VAN(1104) server(1105) to check and transfer.

But in FIG. 39 e-card activates PC banking process, different from FIG. 22, FIG. 23.

In FIG. 23's e-commerce system the owner A takes process of; i)order the product through keyboard(602) by e-commerce company(1106)'s B2B server(402), using ordering program(812) of the check device(600). ii) to perform contract, he connects bank server(226) through VAN(1104) server(1105) and takes process of transfer from his account(220) to company account(1114) by input of security code(312) in security card(310). And the owner(806)'s real time contract ends.

The owner can check his account through check program(808) before transfer(810) through bank server(226).

The VAN directed e-commerce company server(1106) prepares for order of owner A, at the same time checks for confirmation of contract. And it checks for payment in company's account through bank server(226). If the payment is checked, then it organizes circulation base(1108), producer(1110), delivery company(1112)'s PC(408, 412, 410) to deliver the product. And after the delivery is made, the owner confirms it to e-commerce company through circulation base. Then company server connects the bank server(226) to transfer money to producer and delivery company account(1116, 1118). Of course this process includes code input(312) in security card(310). And the real-time e-commerce ends. Server's movement are shown in FIG. 39.

FIG. 26 is flow chart of e-commerce system, following the example of this invention. In order to do real-time e-commerce using check device, it should be changed from card input mode to keyboard input mode. And it must be set on communication mode(1200). This is done with keyboard.

After communication mode set(1200), choice between product order(1203) and PC banking routine(1218) should be made. In product order(1203), either B2B line (1206) or VAN line(1210) will be used, and after log in(1208 or 1210) the product ordering routine(1214) will be activated. Then PC banking routine(1216) will pay for it, and then log out(1228) and communication mode set off(1230) follows. After order the owner waits for delivery.

If proper product is not available, then log-out(1228) and set off(1230) will be directly done.

Here B2B line indicates all the e-commerce server system which the owner can connect to.

That is, e-commerce using the device will be diversified, locally or functionally. And the server will be network-characterized. VAN is not e-commerce company, but under the condition that it will engage in e-commerce actively the VAN line was separated like FIG. 39.

And if the owner fails to pay real-time or need a little time, order and confirmation can be separated by choosing PC banking(1218).

In this case the communication mode(1200) will be set, and PC banking(1218) will be selected in service selection(1202). Then public(208), VAN(1210), bank(1222) line will be chosen in line selection(1220).

In the public line, log-in(306) process is needed. But normally only the bank selection(1224), PC banking routine(1216) will be taken. Then log-off(1228) and set off(1230).

VAN's PC banking mediation is very important in e-commerce, so VAN line is inserted as independent component.

FIG. 27 is a flow chart of real-time e-commerce in check machine following the example of this invention.

FIG. 27 is the case which VAN mediates PC banking and invest or co-run the B2B line of e-commerce company.

And in this case also communication mode set(1200) is needed.

But under cooperation of VAN the set process can be minimized.

After communication mode set(1200), choice between product order(1203) and PC banking routine(1218) should be made. In product order(1203), either B2B line(1206) or VAN line(1210) will be used, and after log in(1208 or 1210) the product ordering routine(1214) will be activated. Then PC banking routine(1216) will pay for it, and then log out(1228) and communication mode set off(1230) follows. After order the owner waits for delivery. If proper product is not available, then log-out(1228) and set off(1230) will be directly done.

And if the owner fails to pay real-time or need a little time, order and confirmation can be separated by choosing PC banking(1218).

In this case the communication mode(1200) will be set, and PC banking(1218) will be selected in service selection(1202). Then the bank selection(1224) and PC banking routine(1216). After that log-in(1228) and set off(1230).

FIG. 28 is a flow chart of real-time e-commerce in check machine following the example of this invention.

FIG. 28 is the case which PC banking will be highlighted in B2B market, like FIG. 24, FIG. 39. That is with PC banking the device becomes e-payment method.

So the device will take larger place in e-commerce and e-card will be widely spread, as bank's strategy of e-finance service. And this will replace the former credit and direct card. It is the situation which the device should take e-card.

FIG. 28a is flow chart of VAN-directed e-commerce company and FIG. 28b is flow chart of e-card activated device.

FIG. 28a is not much different from FIG. 13, except that the B2B connection is more easier. But FIG. 28b is merging of e-card and the device, it will take in the individual and company customers to e-commerce.

By construction of FIG. 28b, e-card owner can pay with the device like direct card. And the owner with e-card will be able to activate PC banning in ordering and paying, as well as finance.

It is far easier with e-card than keyboard, in activating the device. It has no charge limit or recharge needs, so it's more useful. But in this case it should be limited to activating the PC banking routine in the device.

After communication mode set(1200), product order(1203) should be chosen. In product order(1203), B2B line(1206) will be used, and after log in(1212) the product ordering routine(1214) will be activated. Then PC banking routine(1216) will pay for it, and then log out(1228) and communication mode set off(1230) follows. After order the owner waits for delivery. If proper product is not available, then log-out(1228) and set off(1230) will be directly done. And if the owner fails to pay real-time or need a little time, order and confirmation can be separated by choosing PC banking(1218).

In separation FIG. 28b can be more convenient. That is with card activating(1400) the device, PC banking mode(1218) will be automatically set. And bank selection(1224) and PC banking routine(1216). After log-out(1228) the communication mode will be set off(1230) automatically. But in real-time e-commerce it is not a objection because it is already in communication mode.

FIG. 30 is flow chart of product order routine shown in FIG. 27, FIG. 28, FIG. 29. Display of the device cannot show much information with limitation of width 16, length 4 letters. And product ordering will rely much on searching. This chart is drawn under this condition. The order of customer starts with selection of search method(1500). Condition search(1502), code search(1548), classified search(1538) will be chosen. Let's see the case of condition search(1502).

In condition search, conditions like name, price, company will be needed. After input product under proper condition will be displayed(1506) one by one. The display will be composed of name, price, company and amount of product. In searching the screen moving key(back:“J” front:“K” start:“Q” end:“Z”) or enter key(shown as input key in the device) is used. After the choice(1508), the amount other than “0” will be input(1510), and the product ordering mode starts. If the consequence is not proper, it can choose print(1522) by pressing “Z”. Then continue search(1554) or PC banking(1218) or order end(1534) will be chosen. If owner wants end then select end.

And in order mode the amount, price, and code of product is displayed, change can be made through “I” key.

If he wants to continue search(1512), “G” will take him to next product and he can continue search the product by screen moving key. Choice(1508) and amount input(1510) will be repeated. And change and continue search(1512) make it possible to order again.

After order is made, “A” will print(1514) the order and the owner should check(1516) the date, ID, company name, name, price, and amount.

In here he can also use screen moving key(back:“J” front:“K” start:“Q” end:“Z”).

If nothing is wrong, then payment method selection(1524). If somethings wrong, change mode will be inserted.

In change mode he can change amount with “I” key, and it can be printed(1520) and checked(1522) real-time.

It is recommended that the change is limited to 1 time. If the order is proper than payment method selection(1524) or else he can end(1534) the order.

The payment method is banking transfer(810), no account input(1526), and e-card(1004)

All these estimates bank account and transfer possibility. So the routines are not separated. And IC, direct card can be a method, but they will be under the category of e-card. So in here the e-card substitutes all these. The owner only has to input the information shared with e-commerce company. Therefore all those payment methods will lead to bank selection(1528).

After bank is selected, the transfer condition will be displayed by e-commerce company server. It includes company account, transfer code, order price will be transferred through bank transfer, no account input by payment. If owner agrees, then the bank will be connected(1536) or else the order will end(1534). The e-commerce company server is only activated in this case. The server performance is shown in FIG. 39.

In the case of code search, the owner will input(1540) the code, then proper products will be shown(1506). The other process are same with condition search. Code list can be provided through on-line but it is too much to see in the device. So on here the code list will be provided to the owner in off-line. Even term print material to the owner is on consideration with this invention.

And in classified selection, selection1(management, lifestyle, special rights, brand), selection2(home appliances, etc, office, leisure), selection3(temperature conditioner, kitchen appliances, living appliances), selection4(samsung1 smasung2 samsung3) is shown in order. After the display(1506) of the product, the other process is same with condition search.

FIG. 30 is flow chart of PC banking routine shown in FIG. 26, FIG. 27, FIG. 28. PC banking of the check device connects(1600) to the bank and take log-in(1602) process.

Then it differs from what kind of PC banking is wanted. Its subroutine(1605) differs to either the service selection is check(808), transfer(810) or password change(1616). In check account check (1608) and account performance check(1610) is different in input display(1622) and output display(1624). In transfer inner transfer(1612) and outer transfer(1614) is different. Password change is also different to communication password change(1618) or transfer password change(1620).

According to selection(1606), input(1622) and output(1624) follows. If the evidence is needed, it will be printed. Or else the connection ends(1626).

FIG. 31 is flow chart of each service routine shown in FIG. 30. FIG. 31a is account check routine(1608) in FIG. 30. If the account check is selected(1700), the input(1702) and the output(1704) follows. The input is account number and password. The output(1704) is account number, money left, owner, last date, date. And it is arrangeable to display condition of the device.

FIG. 31b is account performance check routine(1610) in FIG. 30. If the account performance check is selected(1700), it is same with input and output, like FIG. 31a. But check start and end date is added ti input(1708). input by date and output is added to the output.

FIG. 31c is inner transfer routine(1612) shown in FIG. 30. If the inner transfer is selected(1712), it is more complicated because it takes input process of security codes(1714) in security card(310). After the code input, the input and output follows. Then it is displayed(1720).

In the case of inner transfer, the input includes account number, account password, destined account number, money, subject, transfer password. Input confirmation is printed as money, fee, and the receiver.

And the output(1720) includes the input(1718), date, account owner, destined account owner, inner transfer number.

FIG. 31d is outer transfer routine shown in FIG. 30. It is same with FIG. 31c that the security code(1724) is needed after selection(1722), and it follows the input-check-display process.

But outer transfer needs bank name in input because it works between different banks. The check(1728) shows also bank name and the output includes bank name and bank number, subject reach.

FIG. 31e is communication password change routine(1618) shown in FIG. 30. If the communication password change(1732) is selected, the simple process of input(1734) and output(1736) follows. The input is before password, after password and repeat. The output is just confirmation.

FIG. 31f is transfer password change routine(1620) shown in FIG. 30.

If the transfer password change(1738) is selected, it is same with password change routine shown in FIG. 28. The input and output follows. Their components are same with communication password change routine shown in FIG. 17e.

FIG. 32 is flow chart of server following the example of this invention. FIG. 32a shows that under the condition that it works real-time, the server will not stop with many users in order for e-commerce to continue.

If the real-time device(1800) is activated, it starts e-commerce(1802) by connecting to the server. then pick a product and put it to his bag(1804), make it clear that the payment will be made(1806). The owner transfers the money to e-commerce company, it compares(1810) customer control DB(532) and customer check DB(534). If it is sure that the payment was made, the company delivers the product(1812, 1814). Then the contract ends(1816). This flow chart shows that e-commerce can be real-time.

With many customers simultaneously on-line, each customer takes step mentioned above. But this assumes that the ordering and confirmation is clear. FIG. 32a shows that with customer duty ending(1812), there should be company duty ending(1814), so the every contract ends(1816) and it will continue unless the system(1818) stops.

FIG. 32b shows module of each routine from FIG. 32a's flow chart. In FIG. 32a the customer demand check routine(1804) is composed of search module(1852) and choice module(1858). The search module has product machine(1854) and customer search machine(1856).

The choice module is composed of; order input(1860), order confirm(1862), order perform(1864), code making(1866), contract ready(1868), check(1870). Customer's contract confirm routine(1806) is made of contract request module(1806). Contract request module(1806) is composed of contract request(1874), contract confirm(1876). Customer contract perform routine(1808) and customer contract perform confirm routine(181) is contract perform module(1878).

Contract perform module(1878) has contract perform machine(1880), delivery ready machine(1882), perform confirm machine(1884). E-commerce company's customer duty perform routine(1812) is composed of delivery module(1886). Delivery module(1886) has delivery order(1888), delivery perform(1890), delivery confirm(1892). E-commerce company's other duty performance routine(1814) is composed of deal completion module(1894). deal completion module has deal completion machine(1896).

FIG. 33 is flow chart of customer's deamnd check routine(1804) shown in FIG. 32a. demand check routine(1804) starts from selecting condition search(1502), classified search(1538), code search(1548) as search method(1506). If customer selects condition search(1502) and put in(1504) the conditions like name, price, company, it print(1506)s the proper products in the device.

And customer sees the product code book which is provided in off-line, before selecting code search(1538). Then the product code is input(1540), it is also printed(1506).

And customer selects classified search(1542), choosing each of sub-class(1544, 1546, 1548, 1550). After classified selection 4, it prints(1506) the proper product.

Classified selection 1-4 means large, medium, small. The printing order is product, price, company, amount.

Then the customer selects(1508) a product and place an order(1510), the server(402) confirms login(1900) before performing the order(1902).

The sub performing routine(1904) is composed of two; making of order control DB(528) from product information DB(522), customer information DB(524), producer information DB(526). And making of order contract information DB(530) from order control code(1906) and transfer control code(1908).

If the order continues(1512), it returns to print(1506) and repeats the process.

In this process the display control differs the search mode, order mode, and change mode, in order to make good input and output.

After the order is completed, the order(1910) is printed in display(1514), with appropriate display control.

The printing(1910) includes date(1912), ID(1914), name(1916), amount(1918), and price(1920).

The customer can check(1516) the order and change it through change routine(1924). The change made can be printed(1520) and checked(1522) real-time. This process is limited to 1 and if it is 2 then connection ends.

Change routine includes amount adjusting(1518). And after these process if the order is confirmed by the customer, contract demand routine takes place.

In FIG. 33, order control code(1906) is named deal code to customer, producing code to producer, and delivery code to delivery company.

Because the order control code is inner code of e-commerce company. It needs to be differed from codes used with other subjects. The code is named according to singularity of contract and difference of the subjects. And transfer control code(1908) is transfer code to customer, and it shows that same code can be in different names according to subject.

FIG. 34 is flow chart of contract demand routine shown in FIG. 32a. Customer's contract demand routine(1806) limits the payment selection(1524) among bank transfer(810), no account input(1526), and e-finance(1004).

And in this case no account input or direct, IC card can ask for e-finance, and with account number e-finance is possible. But in this invention it was not separated because the e-card can include all of those.

In transfer method selection customer can select(1528) the bank among many banks(2002), because it will incite inner transfer, which will ease the contract.

After the banks selection, transfer condition including account number, money, subject is printed, and asks for confirmation(1532). If confirmed, banks e-finance display is shown(1356), if not then the connection ends(1534).

FIG. 35b shows contract performance routine of customer shown in FIG. 32a. Customer's contract perform routine(1808) includes login(1602) to bank which is shown in FIG. 34 by e-commerce company's server, transfer(2100) and connection ending(1626).

Bank transfer(2102) follows the process of; input(2104) of security code, transfer contents(2108) including account number, account password, destined account number, transfer money, subject, transfer password input(2110), printing(2112) of contents, confirmation(2114) and transfer performance&check(2116). The confirmation list from bank server(226) includes the input, money, transfer fee, and name. The result confirmation list includes account owner, destined account owner, inner transfer number, and date. And the destined account number, money, subject should be same with FIG. 35.

So this e-payment has many advantages, compared with former payment methods. It is more secure, and there's no possibility of information left over in server because it uses bank server instead of e-commerce company. And the product is cheaper more than 5% because there's no card charge like credit card.

And direct card owners can use this with e-finance system. There's no need to use card system of the device with charge.

FIG. 36 is flow chart of customer's contract performance confirmation routine shown in FIG. 32a. Customer's contract performance confirmation routine(1810) is composed like; making(2200) of customer receipts control DB(532) from order contract information DB(530), making(2222) of customer check control DB(534) from customer receipts control DB(532), comparison(2224) of the two, sending the results to bank on-line(2228), and activation of next step through receipts confirmation(2230).

E-finance check performance routine is composed of login to the bank, receipts check routine(1610), and ending the connection.

Receipts check routine's check input is composed of account number, account password, check starting date, check ending date. The prints from bank server is account number, money left, owner, receipts, subject, and the time. And the server takes saving step of print material to minimize the check, making the customer check control DB(534). This includes account number, transfer code, receipts, date, time. And if the customer receipts control DB(532) and customer check control DB(534) is same, the confirmation is made.

FIG. 37 is flow chart of customer duty performing routine shown in FIG. 32a. E-commerce company has duty of delivery from the point of time the receipts confirmation is made. The performance routine(1812) starts from delivery order to circulation base PC(408), producer PC(410), delivery company PC(412). The circulation base PC(408) always on the line like FIG. 21, because it is getting data constantly from e-commerce company server(402). Data delivered to circulation base PC includes product information DB(726), circulation information DB(728), delivery information DB(730), delivery control DB(732) and order message DB(734).

The server's delivery order is made from product information in circulation base. The amount and delivery schedule of the base effects the order. If the left is available, it orders the delivery company to deliver the product from circulation base(816) to the customer, and after delivery receives receipt from the customer, and circulation base finally confirms(2308) the delivery by transfer the delivery completion to the e-commerce company.

But if left is not available, then it first orders the producer(822) to delivery the product to circulation base. And then the delivery company can move.

In here it is estimated that circulation PC(408) is controlled directly by e-commerce company. But that does not mean the ownership of circulation base. It is the information of product that is important in e-commerce not the circulation base itself. Therefore the circulation base in FIG. 37 is not fixed in one place.

The base includes other subject owned circulation bases, as well as e-commerce company's. Circulation base needed in this invention does not matter to place or ownership if it is controlled by circulation base PC in e-commerce company.

So the circulation base used by producer is not the one owned by e-commerce company. It is confirmed circulation base which is in best place to deliver the product to customer.

Using this kind of system the distance between producer and receiver can be minimized. So with information about the product in the circulation base, it will automatically decide the fastest way to deliver the product, no matter who the producer or receiver are.

And this invention also enables real-time check of delivery by running “delivery on-line” between e-commerce company server(402) and circulation base PC(408). It can be checked from any of server, circulation base PC(408), delivery company PC(412), producer PC(410). The step 1 is ordering delivery, 2 is entering to circulation base, 3 is outing, 4 is delivery on performance, 5 is confirmation. Each step is composed of on/off signal and it flickers as delivery is performed. And this can be arranged according to delivery schedule or product.

The customer can check the situation by connecting to server. And the server can also do messaging by PC, phone, cellular, and FAX.

FIG. 38 is flow chart of e-commerce company's other duty performance routine, shown in FIG. 32a. It is composed of duties that are not related to customer. After the confirmation is made, the other duties with other e-commerce subjects are still to be performed. So e-finance is used in this process.

This routine is composed of connection(1600), login(1602), transfer routine(2400) to delivery company or producer, and ending connection(1626).

Transfer routine(2402) is composed of; security code input(2404), account number, password, destined account number, transfer money, subject, transfer password input(2408), printing(2414)&confirmation(2412), transfer order&check(2416) and the saving the data(2420) to server. Money, receiver, fee is added in input check, and account owner, destined account number owner, inner transfer, date is added to result check, for the safety of e-payment.

And the transfer should be separated in two, because the delivery company and producer has different accounts. Other routines are same with FIG. 21 except this. After this process all the deal in e-commerce ends.

FIG. 39 is chart of server performance in real-time e-commerce following the example of this invention. And I'll explain the performance of real-time e-commerce in the check device.

Customer connects to e-commerce company server(402) through the check device(404). And search(2506) the product to login(1900) and choose(1508)&place an order(1510). Server(402)'s order system(2508) forms order control DB(528) from product DB(522), customer DB(524), producer DB(526). And code maker(2510) forms order control code(1906) and attache it to order control DB(508). This order control code(1906) forms transfer control code(1908) to save order contract DB(530) with customer(2514) and company(2516), writing the order sheet(2518).

If customer's orders are placed over and over, it repeats itself. If the order ends(1534), it displays(1514) the order and shows payment selection and bank selection, only after confirmation. And then customer chooses a bank, it shows transfer control code(1908), money, account number as transfer condition(1530). And asks for confirmation.

If confirmed, the server(402) registers the contract in the bank on-line corner and calls the delivery process(2524) receipts control process(2520). And shows the e-finance screen in the display ending the connection with customer.

And the customer connects the bank through the line(400) and inputs security code(312) in security card(310). Customer then transfers the money from his account(218) to company's account(2523).

E-commerce company forms customer receipt control DB(532) to perform receipt control(2520). And forms customer check control DB(534) form bank check(2522) to compare(2224) it with customer receipt control DB(532), confirming the contract performance of the customer.

The comparison is decided by agreement of transfer control code. The result is registered to bank online corner real-time.

After confirmation(2230), it sends the money to confirm control DB(542) activates the delivery system(2526).

Bank online corner is composed of on/off signal system, to check the contract in real-time.

This invention's delivery system(2526) starts from delivery order(2300), which corner from delivery DB(538) that is construction of order contract DB(530) and circulation DB(536).

The server(402) sends delivery order to circulation base PC(408), producer PC(410) and delivery company PC(412), to form the delivery control DB(540) and registers it to delivery online corner(2228).

And the contents sent to circulation base PC, producer and delivery company PC differs.

So to circulation base PC(408), product DB(522), circulation DB(536), delivery DB(538) and delivery control DB(540) is sent real-time. And to delivery company, it demands to take the product from the circulation base to the customer. To producer it demands to delivery the product to the circulation base in schedule, according to extra order sheet(2518).

And from circulation base PC(408), the delivery order and in, outing, delivery, confirmation can be checked in delivery online corner(2302).

Every circulation PC(408) is tied as client with e-commerce company server and the data is renewed real-time.

And it is recommended that producer and delivery company PC is structured as server-client system, but not necessarily.

Delivery online corner is run through auto messaging and returning system, which the server checks each contents according to delivery schedule. Messaging method is possible with anything including PC, phone, FAX, and cellular phone.

The real product cannot move through e-media. So in this invention circulation base is run directly by e-commerce company. And delivery schedule of producer and delivery company is included in the customer contract. In this way effective e-commerce is possible.

Therefore customer can check real-time condition of product, in registering, searching and contract confirming.

And delivery is changeable, according to area, amount, time and schedule. So in this invention the delivery schedule is checked by an hour. This is a principle included in the contract.

If the delivery is confirmed(2308) through circulation base PC, the server registers it to delivery control DB(540) and activates the banking transfer system(2528).

Then e-commerce company connects to bank server(226) to transfer money from its account(2530) to producer(826) and delivery company account(828), only through security code(312) in security card input.

And it is recommended that the e-commerce company separates the receipt account and disbursement account, making transfer only be confirmation DB(542)'s signal.

Real-time e-commerce by the check device in this invention lets the owner to do all the process from order to confirm in the place where he is.

And the owner can also buy the product in secure, and still can use the card check device.

Therefore the owner can reduce the expense and he can concentrate on producing. He can provide better services to customer, making more value. This means specialization of the device owners.

Considering the national and world wide owners, the potential of this invention will be great.

The e-commerce server system shown in FIG. 39 means that every communication device with input and output system can be used in e-commerce.

For example, the cellular phone can transform to e-commerce device, with communication program and a few softwares. And only with communication program it can transform into e-commerce device by server input control.

As same case, TV and video can be the device with input device(remote control). This includes PC, notebook, screen phone, etc.

FIG. 40 is key construction according to the invention.

The former device had no key which can transform itself to PC.

And it had only the number key and function key, so korean and english input by the number key was only thing it can do.

So this invention changes and reconstructs the former key construction.

In this case it can create problem if the number keys are re-arranged. So function key and letter key will be used.

To perform this invention many new key setups are required.

As shown in FIG. 40, the new key setups include former key(2600), communication mode on/off(2602), PC banking data transfer(2604), display moving(2606), bank code(2608), print(2610) and product order(2612).

Here the communication mode key(2602) is to transform the device to PC, and has both on and off switch.

PC banking data transfer(2604) has re-input(I), upper menu(M), start menu(T), end(X), transfer confirm(Y), and transfer reject(N).

Display moving is to overcorner the limit of width 16 and length 4 letters screen. It has start screen(Q), end screen(Z), back screen(J), front screen(K), up a line(*), and down a line(#).

Bank code(2608) is for outer transfer, and has view(D) and return(E).

Printing the e-commerce result is different from former device's printing. So separate print machine(2610) is needed.

Printing key has print(P). Product order(2612) is for easier searching and buying, it has continue(G), end(A), banking(B), change(I), and exit(X).

This key construction has important meaning in using other communication devices without keyboards in e-commerce.

For example in cellular, TV remote control and screen phone can be used same way with the device.

All the more under the server-client networking e-commerce system like FIG. 39, many letters and in/out put is done by server. So communication device can activate real-time e-commerce with a few key control.

FIG. 41 is construction of communication connection of the e-commerce card check device following the example of this invention. With limit of width 16 length 4 letters PC banning in the check device requires new display construction.

Through PC communication key shown FIG. 41, the communication mode opens. The service selection(2702) comes up.

The check device owner can choose product order and banking transfer by pressing “1” or “2”.

Line selection(2704) is displayed(618) after choosing the product order from service selection by pressing “1”.

And he can choose B2B and VAN, by pressing “1” and “2”. And each login screen(2706, 2708) comes up.

With ID and password, order method selection(2710) is displayed. Condition search, code search, classified search is possible by “1”, “2”, and “3”.

In service selection(2702), bank transfer is selectable through “2”. And line selection(2712) display(618) is on. And the public line(208), VAN line(1210), bank line(1220) is selectable, through “1”, “2”, and “3”.

If the public line(2712) is selected through “1” key, connection selection(2716) display(618) is on. And the owner selects the connection with number key, login display(2718) is on. And with the ID and password input, bank selection display(2720) is shown, followed by bank login display(2718).

The movement of display(618) is needed in here because so many banks can't be shown in one screen.

So the bank selection display(2720) should show screen moving key(2722).

After the login process in login display(2724), service selection display(2726) is shown, in order for owner to do PC banking.

And in the service selection display(2726), transfer, check, password change is selectable through number key, and the each display follows(2730, 2732, 2734). If the movement of screen is needed then key(2728) such as “Q”, “Z”, “K”, “J” can be used.

If the VAN is selected by pressing “2” in line selection display(2712), bank selection display(1724) is shown.

If the bank line is selected by pressing “3” in line selection display(1702), the bank selection display(2720) is on directly.

And it is same with public line, bank connection display(2720) followed by bank login display(2724).

And this screen construction can be applied to other devices with small screen.

For example it is hard to use cellular phone or screen phone in e-commerce because their screens are too small.

But under the server-client networking e-commerce system the server controls in/output and many letter constructions. So small devices can perform e-commerce.

FIG. 42 is member's register change screen in the card check device.

FIG. 42a is the case which the owner has chosen the register by pressing “1” in the login(2706, 2708) display.

FIG. 42a has up a line and down a line key in upper part of screen. And below follows ID, password, owner number, store name, address, owner name, national security code, bank1, bank2, the device, device number, membership number, business code, phone1, phone2, cellular, and FAX input register screen(2802).

FIG. 42b is the case which the owner has chosen change by pressing “2” in the login(2706, 2708) display.

FIG. 42b has up a line and down a line key in the upper part of the screen. And below is ID display and password, address, phone1, phone2, cellular, FAX, and bank2 change screen(2804).

FIG. 43 is construction of the product ordering in the card device, following the example of this invention.

As shown in FIG. 43, the display(618) shows order method selection(2710) after customer has connected the e-commerce server through B2B or VAN line.

And by pressing “1” in the product ordering method selection condition search is selected. The condition input screen(2900) which has name, price, company, down a line and up a line is shown. Product display(2902) which has name, price, company, amount, front and back key follows.

By pressing “2” code search is selected. Code input screen(2948) which has up a line, down a line and code input is shown. And product display(2902) follows.

By pressing “3” classified search is selected. Classification select screen(2950) which has up a line, down a line and classification is shown.

After selecting a classification the sub-classification screen appears. It is classification selection 2(2952).

And after repeating this process other select screen(2956, 2958) is on. Product print screen(2902) is on with screen moving key “J”.

In the product display(2902), there is screen moving key(2904) for convenient search along with name, price, company, and amount.

By pressing “Z” the end sign and payment selection, key to banking “B”, end “X”(2946) screen(2744) is on.

In product screen(2902) by putting in “0” in amount or moving back one screen other products are shown. And by putting in numbers other than “0”, order change screen(2908) composed of amount, money, and contract code is shown. It has amount change key “I”(2910), continue order “G” and end order “A”.

If customer continues ordering by pressing “G”, product display(2934) is shown, and former processes are repeated.

If customer ends ordering by pressing “A”, order confirm screen composed of date, ID, and company name appears with screen moving key(2918) of back “J”, front “K”, end “Z”.

In first order confirm screen(2916), by pressing “J” order confirm screen(2920) composed of product, money, amount appears.

And this screen also has screen moving key and change “I” key which enables amount change.

In second order confirm screen(2910), it shows name, money, amount, amount change key and screen moving key.

And by moving back the display(2924) which shows amount, total and payment including bank transfer “1”, no account input &Rectversolid; 2&Rectversolid;.

With payment method selection the bank selection display(2928) is on.

And it also needs front a line(*) and back a line(#) key.

By selecting bank, screen input key(2932) composed of agreement “1” and refusal “0” appears. And account number, transfer code and transfer money display(2930) appears.

FIG. 42's display construction is another example of device with small screen working in e-commerce.

With help of the server, e-commerce is possible with small screen.

FIG. 44 is construction of PC banking in/output in the card check device. PC banking in/output display has both contents and keys needed(data transfer, screen control, print, menu moving).

This is for solve the inconvenience in small screen.

As shown in FIG. 44, selecting deposit check by pressing “1” in check code selection(2730) calls input screen which demands account number and password. And the output display(3004) which shows account number, current deposit, owner, last date, and time follows.

And if account performance check is selected by pressing “2”, input screen(3004) which demands account number, password, starting date, and ending date is on. Output screen(3006) which shows account number, current deposit, receipt and payment, and date follows.

In transfer code selection(2732) shown in FIG. 41, inner transfer is selected by pressing “1”. Security code input screen(3010) and input screen which demands account number, password, destined account number, transfer money, subject, and transfer password is on. The output screen which shows account number, destined account number, payment, transfer money, fee, subject, receiver name, transfer confirmation follows.

And this case by pressing “P”, date, account number, account owner, destined account number, destined account owner, subject, payment, transfer money, and bank number is printed through printer part(628).

In transfer code selection(2732) shown in FIG. 41, outer transfer is selected by pressing “2”. Security code input screen(3010) and input screen which demands account number, password, destined account number, transfer money, subject, and transfer password is on. The output screen(3020) which shows account number, destined account number, payment, transfer money, fee, subject, receiver name, transfer confirmation follows.

And then bank code screen(3024) is shown by pressing “D” in input screen(3018).

And this case by pressing “P”, date, account number, account owner, destined account number, destined account owner, subject, payment, transfer money, and bank number is printed through print part(628).

In password change code selection(2734), communication password change and transfer password change is selectable with “1” and “2”. Input screen(3026) which demands before password, after password and repeat, output screen(3028) for confirmation follows.

FIG. 44 is another example of PC banking in small screen.

This is very useful when communication media like cellular phone and screen phone is used as payment methods.

The recommended example of this invention was explained in detail. But with proper knowledge and respect to original spirit of this invention it can be transformed and applied in lots of various ways.

### INDUSTRIAL APPLICABILITY

With this invention the card check device owners can do check and transfer anytime, without moving out of store.

And the card device can provide evidence for e-commerce and e-finance, with its registered characteristics.

With this invention the card check device can work as PC communication media, PC banking media, PC order media. The owners can order and pay for product, check and transfer in account, anytime in his place. And registered device can provide creditable evidence in the contract.

And this invention specializes in using e-finance as payment method. It has same effect with real-time cash paying. And also it is more secure and free from cash. Time and space, all the inconvenience is reduced.

And relations between e-commerce subjects are done real-time, speeding up the circulation speed.

And this client-server e-commerce system targets the card check device owners. So it has great effect in economic terms, for it speeds up the circulation of product in higher level. And this invention combines on-line marketing and off-line marketing of the owner, combining real and financial economy all together with the check device in middle.

1. A card checking device for a PC banking, comprising:
a processor;
a card reader part for generating a card reader signal as a card is read and transmitting the card reader signal to the processor;
a key input part for generating a key input signal depending on a key input and transmitting the key input signal to the processor;
a picture display part for displaying an input picture or an output picture depending on a command signal of the processor, the input picture displaying an item which an input is requested through the key input part, and the output picture displaying a processing result of the processor;
a communication part for connecting the card checking device to an external communications network according to a control of the processor; and
a memory connected to the processor, for storing a card inquiry processing program, a PC communications program, and a PC banking program,
wherein the processor reads out the card inquiry processing program and carries out a card inquiry processing if the card reader signal is input through the card reader part, and the processor reads out the PC banning program and carries out a PC banking processing if the key input signal is input through the key input part.

2. The card checking device of claim 1, wherein the key input signal comprises a checking unit keyboard input signal, a PC banking data transmission key input signal, and a checking unit picture movement key input signal.

3. The card checking device of claim 2, wherein the key input signal further comprises a bank code key input signal including a bank code viewing key input signal and an original position key input signal.

4. The card checking device of claim 2, wherein the checking unit picture movement key input signal comprises a backward picture key input signal which instructs the picture display part to display a backward picture by one frame from a current picture, and a forward picture key input signal which instructs to display a forward picture by one frame from the current picture.

5. The card checking device of claim 2, wherein the checking unit picture movement key input signal comprises an one line below picture key input signal and an one line over key input signal, the one line below picture key input signal instructing the picture display part to display a picture placed below a current picture by one line among pictures related with a processing of the processor, and the one line over picture key input signal instructing the picture display part to display a picture placed over the current picture by one line among the pictures related with the processing of the processor.

6. The card checking device of claim 2, wherein the checking unit picture movement key input signal comprises a first picture key input signal and a last picture key input signal, the first picture key input signal instructing the picture display part to display a first picture among pictures related with a processing of the processor, and the last picture key input signal instructing the picture display part to display a last picture among the pictures related with the processing of the processor.

7. The card checking device of claim 1, further comprising a printing output part, the memory further storing a PC banking result printing program, the key input signal further comprising a checking unit printing output key input signal, the processor reading out the PC banking result printing program from the memory if the checking unit printing output key input signal, and operates the printing output part to print a specification of dealings.

8. The card checking device of claim 1, wherein the PC banking program comprises an account balance check processing routine, a deposit and withdrawal check processing routine, an inner bank transfer processing routine, and an outer bank transfer processing routine.

9. The card checking device of claim 8, wherein the PC banking program further comprises a personal code number changing process routine.

10. The card checking device of claim 1, wherein the communication part connects the card checking device to a bank server through a public network.

11. The card checking device of claim 1, wherein the communication part connects the card checking device to a relay server of a VAN company through a public network.

12. The card checking device of claim 1, wherein the communication part connects the card checking device to a relay server of a VAN company through a leased line.

13. A method of mediating an electronic payment using the card checking device of claim 1, the method comprising the steps of:
receiving a withdrawal account number for designating a withdrawal account, a deposit account number for designating a personal code number and a deposit account, and a transfer content including a transfer amount which is transferred from the withdrawal account number to the deposit account number from the card checking device;
outputting the transfer content to a bank server;
receiving a transfer result from the bank server; and
outputting the received transfer result to the card checking device.

14. The method of claim 13, wherein the transfer content comprises a code number of the deposit bank.

15. The method of claim 13, further comprising the steps of again receiving the transfer content input into the bank server, outputting the transfer content to the card checking device, and confirming whether the transfer content is precisely input or not.

16. A method of carrying out an electronic payment using the card checking device of claim 1, the method comprising the steps of:
inputting a withdrawal account number for designating a withdrawal account, a deposit account number for designating a personal code number and a deposit account, and a transfer content including a transfer amount which is transferred from the withdrawal account number to the deposit account number through the key input part of the card checking device;
outputting the transfer content to a bank server;
receiving a transfer result from the bank server; and
outputting the received transfer result.

17. The method of claim 16, wherein the transfer content comprises a code number of the deposit bank.

18. An electronic commerce method of carrying out a merchandise purchase order using the card checking device of claim 1 and a server, the method comprising the steps of:
receiving a merchandise purchase order from the card checking device;
creating a dealing code as the merchandise purchase order is input, and outputting the dealing code together with a deposit account number to the card checking device; and
confirming whether or not a payment of the merchandise purchase order is received under the dealing code through an electronic financial inquiry.

19. The method of claim 18, further comprising the steps of:
after the step of receiving the merchandise purchase order, outputting a content of the merchandise purchase order to the communication device; and
receiving a signal indicating whether or not to correct the merchandise purchase order.

20. The method of claim 18, wherein the confirming step comprises the steps of:
creating a purchaser deposit management DB from the merchandise purchase order;
creating a purchaser inquiry management DB through the electronic financial inquiry of the deposit account number.

21. The method of claim 18, further comprising a step of outputting an electronic financial system picture of a corresponding bank to the card checking device after the outputting step of the dealing code such that the card checking device enables to connect to the corresponding bank of the deposit account number.

22. The method of claim 18, further comprising a step of transmitting the confirmation result to a banking on-line corner after the confirming step.

23. The method of claim 18, wherein the purchaser connects to the server through the card checking device, and confirms the banking on-line corner.

24. The method of claim 18, wherein the banking on-line corner displays the confirmation result to whether the payment is received by turning a signal lamp on or off in a switching manner.

25. The method of claim 18, further comprising a step of: if it is confirmed that the payment of the merchandise purchase order is received into the deposit account number under the dealing code at the confirming step, outputting a delivery instruction that is necessary for delivering an order merchandise to any one among a merchandise distributing base PC, a merchandise supplier PC, and a delivery company PC based on information of a merchandise distributing base for the order merchandise.

26. The method of claim 25, wherein the delivery instruction is output into the nearest place from a purchaser among the merchandise distributing base PC, the merchandise supplier PC, and the delivery company PC.

27. The method of any one claim of claims 18-26, wherein the computer and the merchandise distributing base PC manages a delivery on-line corner for displaying a delivery progress circumstance.

28. The method of claim 27, wherein the delivery progress circumstance comprises the steps of:
allowing the server to instruct the merchandise distributing base PC to output the delivery instruction;
receiving information transmission that the order merchandise was stocked in the merchandise distributing base;
receiving information transmission that the order merchandise was taken out of the merchandise distributing base; and
confirming that the order merchandise has been delivered through a receipt of acceptance.

29. The method of claim 28, wherein the purchaser accesses to the server through the card checking device, and confirms the delivery on-line corner, thereby checking the delivery progress circumstance.

30. The method of claim 28, wherein the delivery on-line corner displays the delivery progress circumstance by turning a signal lamp on or off in a switching manner.

31. The method of claim 25, further comprising the step of: settling payment on a merchandise supply or the merchandise delivery into a dealing account number of the merchandise supplier or a dealing account number of the delivery company through an electronic financial transfer if a delivery completion signal is input after the step of outputting the delivery instruction.

32. The method of claim 18, wherein the card checking device at which a PC communications program, a PC purchase order program, and a PC banking program are installed is utilized as the communication device.
